(19) United States
(12) Patent Application Publication
(10) Pub. No.: US 2011/0053793 A1
(43) Pub. Date: Mar. 3, 2011

(54) METHODS AND PRODUCTS FOR IDENTIFYING STRAINS OF BACTERIA

(76) Inventors: Alberto Monasterio, Vizcaya (ES); Javier Pascual, Vizcaya (ES); Amaia Toro, Vizcaya (ES); Antonio Martínez, Vizcaya (ES); Laureno Simón, Vizcaya (ES); Jose Maria Marimón, Donostia-san Sebastian (ES); Emilio Perez-Trallero, Donostia-san Sebastian (ES)

(21) Appl. No.: 12/809,526

(22) PCT Filed: Dec. 19, 2008
(86) PCT No.: PCT/GB2008/004220

§ 371 Date: Oct. 18, 2010

Related U.S. Application Data
(60) Provisional application No. 61/016,285, filed on Dec. 21, 2007.

(51) Int. Cl. C40B 30/04; C40B 40/10; C40B 70/00

(52) U.S. Cl. 506/9; 506/18; 506/41

(57) ABSTRACT

Methods for identifying strains of bacteria, particularly methods for serotyping Streptococcus pneumoniae in a sample, methods for detecting and/or classifying S. pneumoniae infection by serotype, array devices and kits for use in such methods are disclosed. Array devices comprise a set of capture antibodies immobilised on a substrate at pre-determined array positions, wherein the set of capture antibodies comprises serotype-distinguishing antibodies which differ in their binding specificity for different S. pneumoniae serotypes. Serotyping methods may employ whole cell detection utilising one or more detectable labels, including in situ labelling of array-bound cells.

### FIELD OF THE INVENTION

The present invention relates to methods and products for identifying strains of bacteria, particularly methods for serotyping Streptococcus pneumoniae in a sample and array devices and kits useful in such methods.

### BACKGROUND TO THE INVENTION

A significant human pathogen Streptococcus pneumoniae (S. pneumoniae or “pneumococci”) was recognized as a major cause of pneumonia in the late 19th century and is the subject of many humoral immunity studies. The encapsulated, Gram-positive coccoid bacteria have a distinctive morphology on Gram stain, the so-called, “lancet shape”. The frequency of infections caused by S. pneumoniae (also known as “pneumococcal” infections) range from low prevalence but life-threatening diseases, such as meningitis, septicaemia and pneumonia, to other much more common but less severe forms of disease, as otitis, sinusitis and conjunctivitis (Musher, 2000). Despite the availability of effective vaccines, S. pneumoniae infections remain currently as a major cause of human disease worldwide. S. pneumoniae is the most common cause of bacterial meningitis in adults and children, and is one of the top two isolates found in otitis media. Pneumococcal pneumonia is more common in children <2 years of age and in the elderly population.

One of the major pathogenicity factors of S. pneumoniae is the polysaccharide capsule that covers the surface of the bacteria. The composition of this capsule elicits a specific immune response that has lead to the description of more than 90 different serotypes of S. pneumoniae according to the antibody response with specific sera (Henrichsen, 1995; Dagan et al., 1997). This serotype specific immune response is the basis of the polyvalent capsular vaccines developed (Perez-Trallero et al., 2005).

The knowledge of the serotypes causing disease remains important. Antimicrobial resistance has been long been associated with certain serotypes (Brueggemann et al., 2004). Furthermore, serotype distribution varies between regions, meaning the epidemiology of pneumococcal disease differs between countries (Hausdorff, 2002). According to estimations by the World Health Organisation (WHO), pneumococcal disease is responsible for about 1 million deaths per year worldwide in children under 5 years of age, especially in South America, Asia and Africa where S. pneumoniae is one of the most common pathogens in children (Pneumococcal vaccines, WHO position paper, 1999). In Europe and North America, pneumococcal pneumonia is responsible for 30% of acquired cases of the pneumonia, with an estimated annual incidence ranging from 5,500 to 9,200 cases per 100,000 people over 65 years of age, and a mortality rate of 10-30% (Pneumococcal vaccines, WHO position paper, 1999). This figure probably underestimates cases of nosocomial pneumonia in hospitals, intensive care units, and other institutions responsible for care of the elderly.

After the introduction of conjugate vaccines for children that elicit a protective response against serotypes included in the vaccine (Whitney et al., 2003) some reports have pointed to a “strain replacement” event, in which the formerly more prevalent vaccine serotypes are replaced by new serotypes (Center, 2007). Importantly, conjugate vaccines prevent the carriage of vaccine serotypes in the nasopharynx of vaccinated people, decreasing their circulation in the population and increasing the proportion of non-vaccine serotypes in the general population (Givon-Lavi, 2003). This makes determining the pneumococcal serotypes in circulation more difficult as most typing schedules are based on the prevalence of several serotypes in a region (Hausdorff, 2005).

Current serotyping techniques can be divided into those that use antibodies for the identification of the pneumococcal serotypes or those based on the amplification of the genes coding the capsule. Among the former, a dot-blot assay (Fenoll et al., 1997), a slide-agglutination method (Mudany et al., 2003), a type-specific ELISA (Lankinen et al., 2004), a latex agglutination test (Slotved et al., 2004), or the more complex multiplex serotype assay (Yu et al., 2005) and bead-based flow cytometric assay (Park et al., 2000) have been described. Among gene amplification techniques multiplex-PCR (Brito et al., 2003; Lawrence et al., 2003; Pai et al., 2006), PCR-RFLP (Batt et al., 2005) and a DNA microarray method (Wang et al., 2007), have been described. A variety of serotyping methods have also been described for bacteria other than S. pneumoniae (Anjum et al., 2006 and Cai et al., 2005). However, the unique properties of the S. pneumoniae capsule represent a particular challenge in comparison with other bacteria.

Among the different typing techniques for S. pneumoniae isolates, the Quellung reaction (Neufeld test or capsular swelling test) remains the “gold standard” (Sorensen, 1993). For this technique collections of pneumococcal antisera are commercially available from the Statens Serum Institut (Copenhagen, Denmark) a recognised reference centre for the typing of pneumococci.

### DISCLOSURE OF THE INVENTION

The present inventors recognised that the Quellung reaction is laborious and has a strong subjective component meaning that it can only be carried out by experienced personnel. Furthermore, other techniques based on using antisera, such as the latex-agglutination test, only allow a limited repertoire of serotypes to be identified and usually serve as complementary techniques to the Quellung reaction rather than as alternatives. The inventors recognised that there is a need for further techniques for serotyping S. pneumoniae, particularly techniques that permit serotyping of larger numbers of samples in a reproducible manner. Surprisingly, the present inventors have found that, notwithstanding the complications of serotyping S. pneumoniae such as the large number of serotypes, the properties of the bacterial capsule and the complex mixture of capsular antigens, serotyping can be carried out directly “on chip”, by means of a method employing an antibody array.

The present inventors have found that S. pneumoniae cells in a sample can be captured in a serotype- and location-specific manner on an antibody array, whereby detection of the captured cells at a particular array location or locations provides an indication of the serotype or serotypes of S. pneumoniae in the sample. The array positions of the different capture antibodies are pre-determined and thus addressable. Therefore, the position(s) of captured cells on the array provide “addresses” that can be readily related to one or more particular serotypes of S. pneumoniae (e.g. by reference to a key or other identifier and/or using software-implemented algorithms for analysis). The specificities and locations of the antibodies of the array may be selected so that each serotype in a set of serotypes of S. pneumoniae to be detected will bind the array with a unique binding “signature” (i.e. the particular array location or locations at which the cells are bound). The signature thus indicates the serotype or serotypes of S. pneumoniae in the sample.

Accordingly, in one aspect the present invention provides a method for identifying one or more serotypes of S. pneumoniae in a sample containing, or suspected to contain, S. pneumoniae cells, comprising:
contacting an antibody array with the sample, the array comprising a set of capture antibodies immobilised on a substrate at pre-determined array positions, wherein the set of capture antibodies comprises serotype-distinguishing antibodies which differ in their binding specificity for different S. pneumoniae serotypes; and
detecting binding of S. pneumoniae cells to a subset of the set of capture antibodies, which subset corresponds to one or more particular serotypes of S. pneumoniae.

The use of an antibody array to capture whole cells of S. pneumoniae in a location- and serotype-specific manner provides a method of serotyping S. pneumoniae in fewer steps compared with previously described methods (e.g. the method described by Sorensen, 1993). Avoiding or reducing the need for sequential steps of antibody-bacteria interaction with different antibodies or antibody pools is particularly advantageous in a clinical setting where rapid serotyping may be required, e.g. for diagnosis or to inform treatment or vaccination strategy. The capture and detection of whole cells removes the need for a separate cell lysis step employed in certain methods described previously (Yu et al., 2005). In some cases, the methods of the invention (and antibody arrays of the invention) may be scaled-up for high-throughput serotyping. The high-throughput approach provides a substantial advantage for screening a population of samples, such as might be required in a hospital setting. In many cases the invention permits high-throughput serotyping of large numbers of samples in a reproducible and objective manner. This is a significant advantage as it removes or diminishes the need for experienced technical personnel to perform the serotyping procedure and/or to interpret the resulting data. In particular, the expertise required for performing the method of the invention will generally be substantially lower than that of existing methods of serotyping S. pneumoniae (such as the Quellung reaction). Furthermore, the cost of the serotyping procedure in accordance with the invention may be reduced as compared with existing S. pneumoniae serotyping methods. In particular, the array of the invention may be miniaturised (see “microarray” below) allowing the amount of each reagent and sample required to be reduced. The sample may be any sample as further defined herein.

Detecting binding of S. pneumoniae cells to a subset of the set of capture antibodies may comprise determining the array position or positions at which S. pneumoniae cells are bound. The pre-determined array positions at which the capture antibodies are bound are thus correlated with the array position or positions at which S. pneumoniae cells are bound thereby indicating the particular serotype or serotypes of S. pneumoniae present in the sample. Determining the array position or positions at which S. pneumoniae cells are bound may be facilitated by labelling the S. pneumoniae cells with at least one detectable label (before during or after contacting the array with the sample). The at least one detectable label may be selected from: a fluorescent dye; a labelled antibody capable of binding an antigen present on the surface of an S. pneumoniae cell; a labelled binding agent having affinity for the surface of an S. pneumoniae cell; and a visible cell staining agent.

The present inventors have surprisingly found that, despite the polysaccharide capsule surrounding the S. pneumoniae cell, it is possible to label many serotypes of S. pneumoniae with a cell-penetrating fluorescent dye (e.g. a DNA-labelling dye). This provides a relatively straightforward labelling technique for labelling the S. pneumoniae cells in a sample. Whole cell labelling allows the array location or locations of cell capture on the array to be determined readily. In particular, a single image may identify the serotype of S. pneumoniae present in the sample.

In some cases, for example when it is desired to serotype a sample that contains, or is suspected to contain, serotype 3 S. pneumoniae cells, the method of the invention may comprise treating the sample so as to render the serotype 3 cells permeable to a detectable label (e.g. a fluorescent dye such as SYTO 25). The permeabilising treatment may comprise: an alkali treatment (e.g. exposing the sample to pH in the range of 10-12, preferably around pH 11), an acid treatment (e.g. exposing the sample to pH in the range of 3-5, preferably around pH 4) and/or a sonication treatment (e.g. immersion of the sample in a sonication bath for around 1 minute). The permeabilising treatment is preferably carried out prior to labelling of the sample with a detectable label, such as a cell-penetrating fluorescent dye.

In certain cases, the method for identifying one or more serotypes of S. pneumoniae in accordance with the invention may comprise labelling of S. pneumoniae cells “on chip”, i.e. the bacteria are incubated on the array surface, and the detectable label (e.g. a fluorescent dye) is then added. Labelling on chip (also referred to as “in situ” labelling) has been found to minimise the need for standardisation of the bacterial cell concentration in the sample to the extent that such standardisation may be optional. In particular, in certain cases the methods of the present invention make it possible to avoid one or more of the steps of: liquid culture of the sample; optical density (“OD”) determination of the sample; and adjustment of the sample OD (e.g. by dilution, centrifugation and re-suspension or further culture of the sample) prior to serotyping S. pneumoniae cells of the sample. Thus, labelling of the S. pneumoniae cells on the array surface can significantly reduce protocol time and is also less prone to operator error that may be inherent in steps of determining and adjusting optical density of the sample.

Thus in certain cases the method for identifying one or more serotypes of S. pneumoniae in accordance with the invention may comprise the following steps:
(i) optionally, incubating a sample containing, or suspected to contain, S. pneumoniae cells under cell growth conditions;
(ii) optionally, determining the concentration of bacterial cells in the sample;
(iii) optionally, adjusting the concentration of bacterial cells in the sample;
(iv) optionally, subjecting the sample to one or more cell
   permeabilising treatment steps selected from: an alkali treatment (e.g. exposing the sample to pH in the range of 10-12, preferably around pH 11), an acid treatment (e.g. exposing the sample to pH in the range of 3-5, preferably around pH 4) and a sonication treatment (e.g. immersion of the sample in a sonication bath for around 1 minute);
(v) contacting an antibody array with the sample, the array comprising a set of capture antibodies immobilised on a substrate at pre-determined array positions, wherein the set of capture antibodies comprises serotype-distinguishing antibodies which differ in their binding specificity for different S. pneumoniae serotypes (e.g. serotype-distinguishing antibodies as further defined herein);
(vi) optionally, subjecting the array substrate to one or more wash steps to remove unbound cells;
(vii) contacting a plurality of S. pneumoniae cells bound to one or more of the capture antibodies with at least one detectable label (e.g. one or more detectable labels as further defined herein);
(viii) optionally, subjecting the array substrate to one or more wash steps to remove excess detectable label; and
(ix) determining the array position or positions of said at least one detectable label, whereby said array position or positions correlate to a subset of the set of capture antibodies to which subset the labelled S. pneumoniae cells are bound, which subset corresponds to one or more particular serotypes of S. pneumoniae. The antibody array may be any antibody array as further defined herein. Determining the array position or positions of said at least one detectable label may comprise visual inspection (e.g. microscope visualisation) and/or capturing of an image of the array and subsequent analysis of the image. When said at least one detectable label comprises a fluorescent label, determining the array position or positions of said at least one detectable label may employ confocal microscopy.

In certain cases, the method for identifying one or more serotypes of S. pneumoniae in accordance with the invention may comprise use of more than one detectable label. This is advantageous when one detectable label is unable to or has limited ability to label all serotypes of S. pneumoniae under consideration. The use of complementary detectable labels may be employed in order to label all serotypes of S. pneumoniae under consideration. Therefore, the methods of the present invention address the hitherto unappreciated difficulties in labelling S. pneumoniae cells of a wide variety of serotypes.

In a further aspect, the present invention provides a method of complementary labelling of S. pneumoniae cells, comprising contacting (e.g. incubating) a sample that contains or is suspected to contain S. pneumoniae cells with a first detectable label that is capable of labelling at least a subset of the known S. pneumoniae serotypes and wherein said sample is further contacted with a second detectable label that is capable of labelling at least one S. pneumoniae serotype that is not labelled or is only poorly labelled by said first detectable label. The first detectable label may be a fluorescent dye (e.g. a DNA labelling dye such as SYTO 25). The second detectable label may be a labelled antibody capable of binding an antigen present on the surface of an S. pneumoniae cell (e.g. a labelled antibody capable of binding a capsular antigen common to all S. pneumoniae serotypes or a labelled antibody capable of binding a capsular antigen present on S. pneumoniae serotype 3). The labelled antibody may comprise a fluorophore (phycoerythrin or an Alexa fluorophore) or a chromogen coupled to the antibody covalently or via a high affinity interaction such as streptavidin-biotin.

In a further aspect the present invention provides an antibody array for serotyping S. pneumoniae cells, comprising a set of capture antibodies immobilised on a substrate at pre-determined array positions, wherein the set of capture antibodies comprises serotype-distinguishing antibodies which differ in their binding specificity for different S. pneumoniae serotypes. The set of capture antibodies and the pre-determined array positions at which they are immobilised are selected such that each serotype in a set of serotypes of S. pneumoniae to be detected will bind the array with a unique binding “signature” (i.e. the particular array location or locations at which the cells are bound). The signature thus indicates the serotype or serotypes of S. pneumoniae in the sample. The serotype-distinguishing antibodies may comprise: type-specific antibodies, each type-specific antibody being selective for a single serotype of S. pneumoniae; factor-specific antibodies, each factor-specific antibody being selective for one or more serotypes of S. pneumoniae of a single S. pneumoniae serotype group; group-specific antibodies, each group-specific antibody being selective for a single S. pneumoniae serotype group; and/or combinations thereof (“pooled antibodies”). The set of capture antibodies may comprise antibodies of any antibody format as further defined herein, including polyclonal antibodies, monoclonal antibodies and antigen binding fragments thereof. The set of capture antibodies preferably comprises polyclonal antisera raised against S. pneumoniae capsule antigens. The set of capture antibodies may further comprise omniserum and/or anti C-polysaccharide antibodies, which act as positive controls capable of capturing all 91 known serotypes of S. pneumoniae (i.e. 90 previously known serotypes plus the recently-identified serotype 6C).

The antibody array of the invention and for use in accordance with methods of the invention may be a antibody microarray or an antibody macroarray. As used herein a “microarray” refers to a miniaturised array requiring microscopic or otherwise assisted examination for detection of cell binding. A plurality (such as 5, 10, 14, 16, 96, 384, 1536 or more) of individual antibody microarrays in accordance with the invention may be provided on a single substrate (e.g. a slide or microtitre plate). Microtitre plates are available in a variety of formats including 96-, 384- and 1536-well formats. Alternatively, the antibody array may be an antibody macroarray of dimensions suitable for visualisation by the naked eye. Detection of cell binding to the antibody macroarray of the invention may be carried out without specialised microscope equipment, and is thus suitable for applications in less advanced settings (e.g. field hospitals or underdeveloped countries).

As will be appreciated, a large variety of array layouts, using different combinations of capture antibodies are possible, provided that each serotype in a set of serotypes of S. pneumoniae to be detected will bind the array with a unique binding “signature” (i.e. the particular array location or locations at which the cells are bound). In some cases, the antibody array of the invention comprises serotype-distinguishing antibodies that are capable of distinguishing the following S. pneumoniae serotypes: 1, 2, 4, 5, 6A, 6B, 7F, 8, 9N, 9V, 10A, 11A, 12F, 14, 15B, 17F, 18C, 19A, 19F, 20, 22F, 23F and 33F, and optionally S. pneumoniae serotype 3. This combination of serotypes is of particular interest because it covers 22 of the 23 serotypes of S. pneumoniae included in the 23-valent vaccine. In some cases the antibody array of the invention comprises serotype-distinguishing antibodies that are capable of distinguishing the following S. pneumoniae serotypes 1, 2, 3, 4, 5, 6A, 6B, 7F, 7A, 7B, 7C, 8, 9A, 9L, 9N, 9V, 10F, 10A, 10B, 10C, 11F, 11A, 11B, 11C, 11D, 12F, 12A, 12B, 13, 14, 15F, 15A, 15B, 15C, 16F, 16A, 17F, 17A, 18F, 18A, 18B, 18C, 19F, 19A, 19B, 19C, 20, 21, 22F, 22A, 23F, 23A, 23B, 24F, 24A, 24B, 25F, 25A, 27, 28F, 28A, 29, 31, 32F, 32A, 33F, 33A, 33B, 33C, 33D, 34, 35F, 35A, 35B, 35C, 36, 37, 38, 39, 40, 41F, 41A, 42, 43, 44, 45, 46, 47F, 47A and 48, and optionally 6C. Other combinations of serotypes of interest will be apparent to the skilled person, for which an appropriate array layout and combination of capture antibodies may be selected in accordance with the present invention.

In a further aspect the present invention provides a method of producing an antibody array of the invention, comprising printing a set of antibodies on a array surface, wherein serotype-distinguishing antibodies that differ in their binding specificity for different S. pneumoniae serotypes are immobilised on the array surface at different locations. Where the antibody array of the invention is an antibody microarray, said printing may employ a contact printer device capable of printing microscopic spots, e.g. spots having a diameter of less than 500 μm, such as a diameter in the range of 100-200 μm.

In a further aspect the present invention provides use of an antibody array, of the invention for serotyping S. pneumoniae cells. In particular, the method for identifying one or more serotypes of S. pneumoniae in a sample containing, or suspected to contain, S. pneumoniae cells may, in accordance with the invention, comprise:
contacting an antibody array of the invention with the sample; and
detecting binding of S. pneumoniae cells to a subset of the set of capture antibodies, which subset corresponds to one or more particular serotypes of S. pneumoniae. The sample may be any sample as further defined herein.

In a further aspect the present invention provides a method of assessing (such as diagnosing) pneumococcal infection of a mammalian subject (particularly a human subject), comprising:
contacting an antibody array of the invention with a sample that has been obtained from said subject; and
detecting binding of S. pneumoniae cells to a subset of the set of capture antibodies, which subset corresponds to one or more particular serotypes of S. pneumoniae,
thereby assessing the S. pneumoniae serotype or serotypes associated with the pneumococcal infection of the subject. Said sample obtained from said subject may be a bodily fluid, such as otitis media, nasopharyngeal fluid, sputum, blood or cerebrospinal fluid (CSF).

The method of assessing pneumococcal infection of a mammalian subject may further comprise the step of treating the subject with a pharmacological agent (e.g. an antibiotic) appropriate for the S. pneumoniae serotype or serotypes found to be associated with said pneumococcal infection.

The method of assessing pneumococcal infection of a mammalian subject may be expanded to assess pneumococcal infection prevalent in a population of mammalian subjects, wherein a plurality of antibody arrays of the invention are contacted with samples obtained from said population of mammalian subjects. The expanded method may thus determine the S. pneumoniae serotype or serotypes common in the population, thereby informing vaccination strategies for the population.

In a further aspect the present invention provides a kit for identifying one or more serotypes of S. pneumoniae in a sample, comprising an antibody array of the invention together with one or more reagents, controls and/or standards, and optionally further comprising computer readable media having stored thereon a computer program for analysis of an antibody array read-out, e.g. to facilitate the determination of serotype(s).

The present invention includes the combination of the aspects and preferred features described except where such a combination is clearly impermissible or is stated to be expressly avoided. These and further aspects and embodiments of the invention are described in further detail below and with reference to the accompanying examples and figures.

### DESCRIPTION OF THE FIGURES

FIG. 1 shows the design layout of the PneumoChip-23 Microarray a different printed probe. The 361-element array contains a 4-element capture dilution series printed in duplicate for each factor (6b, 6c, 7b, 9e, 9g, 10b, 10d, 11b, 11c, 11f, 12b, 12e, 15h, 17b, 18c, 18f, 19b, 19c, 22b, 23b, 33b and 20b), type (1, 2, 3, 4, 5, 8, 14 and 20) and group serum (6). These are shown as shaded boxes in the array grid. Furthermore, the layout includes a 3-element capture dilution series in duplicate for each pool serum (from pool A to pool I) and omniserum (OMS). In addition, controls are shown: BSA and printing buffer as negative controls and streptevidin-Cy3 (Cy3) as anchorage points for the grid.

FIG. 2 shows fluorescence micrographs used to identify the serotype of 23 different serotypes of Streptococcus pneumoniae included in the PneumoChip-23 Microarray. (The wells of the PneumoChip-23 Microarray are shown in detail.) Each image shows a well corresponding to an incubation with a particular serotype as indicated in the text above the image. Positive signal is detected in each case for the specific serotype in the 2 by 4 vertically-orientated matrix of printed points of the specific antiserum (four dilutions in duplicate), as indicated in each well image. The horizontally-orientated 3 by 2 matrix of positive signals correspond to the binding to the antiserum pools A-I that were printed in duplicate at 3 dilution points.

FIG. 3 shows fluorescence micrographs used to identify serotype 3 of S. pneumoniae using a sandwich method detection with a labelled antiserum. Specific antiserum for serotype 3, labelled with biotin and conjugated with streptavidin-phycoerythrin, was used as detection molecule instead of SYTO 25 for the identification of the serotype 3 strain. Signal was obtained in type serum 3 and in pool B.

FIG. 4 shows a further design layout (referred to herein as the “PneumoArray”) of a different printed probe. The 484-element array contains a 6-element capture series (replicates) for each factor (6b, 6c, 7b, 7c, 9e, 9g, 10b, 10d, 11b, 11c, 11f, 12b, 12e, 15b, 15c, 15h, 16b, 17b, 18c, 18f, 19b, 19c, 7h, 22b, 23b, 23c, 33b and 20b), type (1, 2, 3, 4, 5, 8, 13, 14, 20, 21, 27, 29, 31, 34, 36, 37, 38 and 39) and group serum (6, 7, 9, 10, 11, 12, 15, 16, 17, 18, 19, 20, 22, 23, 24, 25, 28, 32, 33, 35, 41 and 47). In addition, spots containing streptavidin-Cy3 (S-Cy3) are shown as anchorage points for the grid (shaded).

FIG. 5 shows fluorescence micrographs used to identify the different serotypes of Streptococcus pneumoniae using the PneumoArray. The wells of the PneumoArray are shown in detail for some representative serotypes (1, 5, 6B, 9V, 16A, 18B, 19F, 23B, 32A, 33F, 35C and 41). Each image shows a well corresponding to an incubation with a particular strain the serotype of which is indicated in the text above the image. As indicated in each well image, positive signal is detected in each case for the specific serotype in the 2 by 3 vertically-orientated matrix of printed points of the specific antiserum (six replicates) or in the horizontally-orientated 3 by 2 matrix of positive signals in the case of serotype 41.

FIG. 6 shows fluorescence micrographs used to identify serotype 3 of S. pneumoniae using a sandwich method detection with a labelled antiserum. The array utilises a further exemplary array layout. Specific antiserum for serotype 3, labelled directly with Alexa-647 (without biotin), was used as detection molecule instead of SYTO 25 for the identification of the serotype 3 strain. The data were collected from measurements at 532 nm (SYTO 25) and 635 nm (Alexa-647). The figure shows the differentiation of serotype 3 (right) from other mucoid strains (serotypes 8 and 6B, left).

### DETAILED DESCRIPTION OF THE INVENTION

### Streptococcus pneumoniae

Streptococcus pneumoniae (S. pneumoniae or “pneumococcus”) refers to the Gram-positive, alpha-hemolytic, diplococcus bacterium that is a member of the genus Streptococcus.

### Serotype

Serotype refers to a grouping of a micro-organism based on surface antigens. Serotypes allow organisms to be classified at the sub-species level, an issue of particular importance in epidemiology.

At present, 91 different S. pneumoniae serotypes are known. The serotypes differ in terms of their capsular antigens. Furthermore, the serotypes of S. pneumoniae show differences in their virulence, prevalence and/or the extent to which they display antibiotic drug resistance.

As used herein, S. pneumoniae bacteria are classified according to the Danish nomenclature system into the following 91 known serotypes: 1, 2, 3, 4, 5, 6A, 6B, 6C, 7F, 7A, 7B, 7C, 8, 9A, 9L, 9N, 9V, 10F, 10A, 10B, 10C, 11F, 11A, 11B, 11C, 11D, 12F, 12A, 12B, 13, 14, 15F, 15A, 15B, 15C, 16F, 16A, 17F, 17A, 18F, 18A, 18B, 18C, 19F, 19A, 19B, 19C, 20, 21, 22F, 22A, 23F, 23A, 23B, 24F, 24A, 24B, 25F, 25A, 27, 28F, 28A, 29, 31, 32F, 32A, 33F, 33A, 33B, 33C, 33D, 34, 35F, 35A, 35B, 35C, 36, 37, 38, 39, 40, 41F, 41A, 42, 43, 44, 45, 46, 47F, 47A and 48. S. pneumoniae serotype classification is discussed in Kauffman (1960), the entire disclosure of which is specifically incorporated herein by reference.

In some cases, two or more S. pneumoniae serotypes fall into the same group (“serogroup”) (e.g. serogroup 6 comprises serotypes 6A, 6B and the recently-described 6C). Serotypes of the same group will typically share at least one common capsular antigen, but differ in respect of one or more other capsular antigens. For example, serotype 6A exhibits antigens 6a and 6b, whereas serotype 6B exhibits antigens 6a and 6c.

### Sample

The sample for use in accordance with any the methods of the invention may be a clinical sample obtained from a mammalian subject (e.g. a bodily fluid, such as otitis media, nasopharyngeal fluid, sputum, blood or cerebrospinal fluid (CSF)), a laboratory sample (e.g. an isolated bacterial strain) or an environmental sample (e.g. a food or drink sample, a work surface sample, a sample obtained from clothing or other articles or a sample obtained from a clinical environment, including a swab sample). The sample is preferably a liquid sample. The sample will generally be known to contain or suspected to contain S. pneumoniae cells. Preferably, the sample is a sample which tests positive in the optoquin-sensitivity test (Bowen, 1957; the disclosure of which is incorporated herein by reference in its entirety), indicating that the sample contains S. pneumoniae cells. Accordingly, the method for identifying one or more serotypes of S. pneumoniae in accordance with the invention may comprise a step of assessing whether or not the sample contains optoquin-sensitive bacterial cells.

In accordance with the methods of the invention, the sample may be incubated under bacterial growth conditions prior to use. Bacterial growth conditions are any conditions suitable to allow S. pneumoniae cells to grow and/or multiply. The conditions may be 37° C. and 5% CO₂, and may include suitable growth media. Growth media may comprise plate culture (e.g. culture on plates containing blood agar) or liquid culture (e.g. culture in Todd-Hewitt growth medium (CM0189, Oxoid, Hampshire, UK) enriched with 0.5% Yeast extract (LP0021, Oxoid)). The sample may be incubated for more than 2 hours, for example, 4, 6, 12, 16, 24 or 48 hours. Preferably the sample is incubated for at least 16 hours.

The sample may be diluted and/or grown as necessary to achieve a pre-determined cell concentration or concentration range. The cell concentration may be measured directly by cell counting or indirectly by measuring e.g. protein content in the sample or determining the OD of the sample. Adjustment of the sample to a pre-determined cell concentration or concentration range is advantageous in some cases in order to standardise the cell concentration of the sample prior to contacting the antibody array with the sample. In this way the cell concentration may be matched to the optimal concentration for capture by the set of capture antibodies of the array. In some cases, such as but not limited to methods employing “on chip” labelling described above, the method for identifying one or more serotypes of S. pneumoniae in accordance with the invention may omit one or more of the following steps: liquid culture of the sample; optical density (“OD”) determination of the sample; and adjustment of the sample OD (e.g. by dilution, centrifugation and re-suspension or further culture of the sample) prior to serotyping S. pneumoniae cells of the sample.

### Antibody

As used herein with reference to the methods, arrays and kits of the invention, the term antibody (or antibodies) includes any immunoglobulin whether natural or partly or wholly synthetically produced. The term antibody includes monoclonal antibodies and polyclonal antibodies (including polyclonal antisera). Antibodies may be intact or fragments derived from full antibodies (see below). Antibodies may be human antibodies, humanised antibodies or antibodies of non-human origin. “Monoclonal antibodies” are homogeneous, highly specific antibody populations directed against a single antigenic site or “determinant” of the target molecule. “Polyclonal antibodies” include heterogeneous antibody populations that are directed against different antigenic determinants of the target molecule. The term “antiserum” or “antisera” refers to blood serum containing antibodies obtained from immunized animals.

It has been shown that fragments of a whole antibody can perform the function of binding antigens. Thus reference to antibody herein, and with reference to the methods, arrays and kits of the invention, covers a full antibody and also covers any polypeptide or protein comprising an antibody binding fragment. Examples of binding fragments are (i) the Fab fragment consisting of VL, VH, CL and CH1 domains; (ii) the Fd fragment consisting of the VH and CH1 domains; (iii) the Fv fragment consisting of the VL and VH domains of a single antibody; (iv) the dAb fragment which consists of a VH domain; (v) isolated CDR regions; (vi) F(ab′)₂ fragments, a bivalent fragment comprising two linked Fab fragments (vii) single chain Fv molecules (scFv), wherein a VH domain and a VL domain are linked by a peptide linker which allows the two domains to associate to form an antigen binding site; (viii) bispecific single chain Fv dimers (WO 93/11161) and (ix) “diabodies”, multivalent or multispecific fragments constructed by gene fusion (WO94/13804; 58). Fv, scFv or diabody molecules may be stabilised by the incorporation of disulphide bridges linking the VH and VL domains. Minibodies comprising a scFv joined to a CH3 domain may also be made.

### Antibody Array

The antibody array of the invention and which is for use in the methods of the invention comprises a set of capture antibodies immobilised on a substrate at pre-determined array positions, wherein the set of capture antibodies comprises serotype-distinguishing antibodies which differ in their binding specificity for different S. pneumoniae serotypes. The substrate on which the capture antibodies are immobilised may be any suitable surface, including epoxy-coated slides, glass, synthetic membranes, wells of microtitre plates, mass spectrometer plates, beads or other particles. The substrate preferably comprises a planar surface.

The set of capture antibodies may be as defined further herein. The capture antibodies are “immobilised” to the extent that they are constrained or anchored to particular pre-determined positions. Generally, the capture antibodies are resistant to removal by normal washing steps employed in the methods of the invention. The capture antibodies may be spotted or printed on the substrate using, e.g. a contact printing device. Each antibody or pool of antibodies in the set of capture antibodies, in particular each serotype-distinguishing antibody, may be printed in serial dilutions (e.g. 2, 3 or 4 serial dilutions) and may be printed in duplicate (e.g. pairs of 2, 3 or 4 serial dilutions).

The capture antibodies are immobilised at pre-determined array positions. The layout may be any layout that permits the S. pneumoniae serotypes under consideration to be distinguished. The pre-determined array locations preferably form an ordered array, such as a grid or other regular pattern. The capture antibodies may be spotted in a grid array wherein the spot diameter may be 100-200 μm (e.g. 140 μm); and the centre-to-centre spacing may be 200-400 μm (e.g. 240 μm).

The array may comprise negative control array elements. For example, at certain array locations an inert agent may be spotted that does not capture S. pneumoniae cells. The inert agent may comprise bovine serum albumin (BSA) and/or printing buffer.

The array may comprise one or more anchor points for imaging registration of the array. In certain embodiments, the array anchor points may comprise a pattern of spots (such as multiple grid positions) along one or more edges of a planar array surface and/or one or more lines of anchor points, e.g. extending transversely across the surface of the array. The anchor points may comprise a detectable label, such as a fluorescent dye immobilised on the substrate, e.g. streptavidin-Cy3.

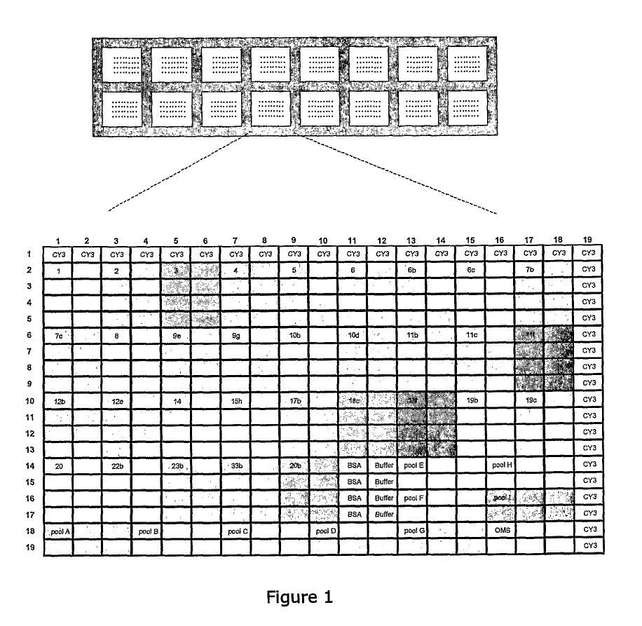

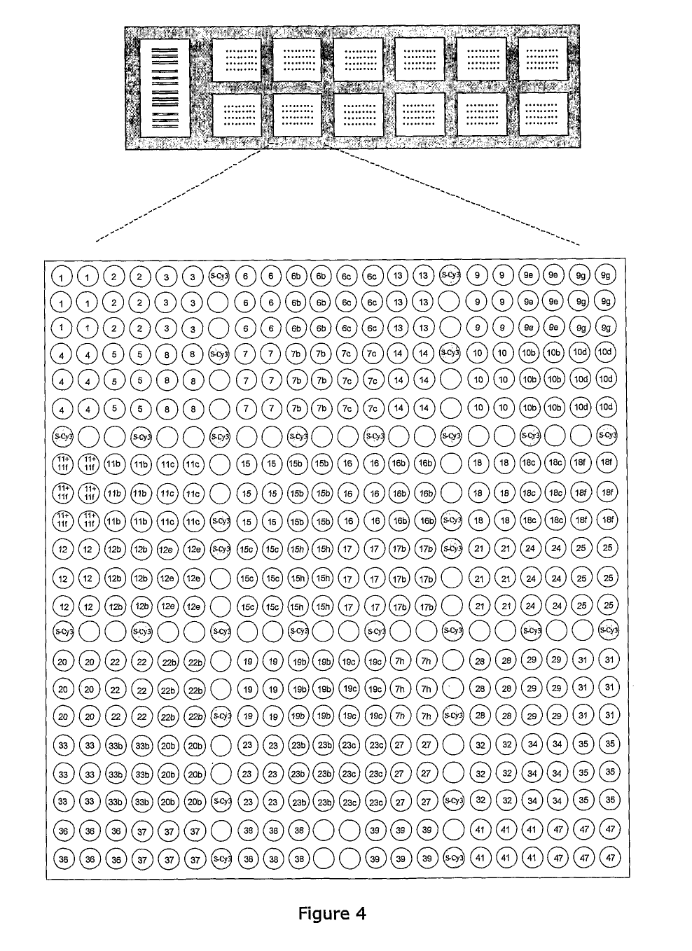

The array may be a 19×19 grid or a 22×22 grid having the set of capture antibodies, negative control array elements and anchor points in a layout as depicted in FIG. 1 or FIG. 4, respectively.

The antibody array of the invention and for use in accordance with methods of the invention may be a antibody microarray or an antibody macroarray. As used herein a “microarray” refers to a miniaturised array requiring microscopic or otherwise assisted examination for detection of cell binding. Several (such as 5, 10, 14, 16 or more) individual antibody microarrays in accordance with the invention may be provided on a single substrate (e.g. a slide or microtitre plate). Alternatively, the antibody array may be an antibody macroarray of dimensions suitable for visualisation by the naked eye.

### Capture Antibodies

The set of capture antibodies comprises antibodies capable of binding S. pneumoniae cells. The set of capture antibodies preferably comprises a plurality of antibodies having binding specificity for surface antigens of S. pneumoniae, including capsular antigens. By recognising and binding to surface antigens, the capture antibodies—immobilised on the substrate—are able to capture whole S. pneumoniae cells exhibiting the relevant antigen or antigens. This avoids the need to lyse cells the bacterial cells prior to serotyping as the relevant antigens are already exposed in the cells native state. The set of capture antibodies may comprise or consist of polyclonal antisera and/or monoclonal antibodies that bind S. pneumoniae capsular antigens.

### Serotype-Distinguishing Antibodies

The set of capture antibodies comprises serotype-distinguishing antibodies which differ in their binding specificity for different S. pneumoniae serotypes. The layout of the various serotype-distinguishing antibodies on the array substrate at their pre-determined array positions together with the ability of the serotype-distinguishing antibodies to discriminate between various S. pneumoniae serotypes permits serotype- and location-specific capture of S. pneumoniae cells.

The serotype-distinguishing antibodies may be selected so that each serotype in a set of serotypes of S. pneumoniae to be detected will bind the array with a unique binding signature (i.e. the particular array location or locations at which the cells are bound).

In some cases, the serotype-distinguishing antibodies may include a panel of antibodies each selective for a single serotype of S. pneumoniae. In this way the serotype-specific antibodies correlate to particular serotypes in a 1-to-1 fashion. For example, when the set of serotypes of S. pneumoniae to be detected comprises serotypes: 1, 2, 3, 4, 5, 6A, 6B, 7F, 8, 9N, 9V, 10A, 11A, 12F, 14, 15B, 17F, 18C, 19A, 19F, 20, 22F, 23F and 33F, the serotype-distinguishing antibodies may include a panel of type-specific and factor-specific antibodies as defined further herein. In another example, when the set of serotypes of S. pneumoniae to be detected comprises serotypes: 1, 2, 3, 4, 5, 6A, 6B, 7A, 7F, 7B/C, 8, 9N, 9V, 9A/L, 10A, 10B, 10C/F, 11A, 118/C/D/F, 12A, 12B, 12F, 13, 14, 15A, 156, 15C, 15F, 16A, 16F, 17A, 17F, 18A/B, 18C, 18F, 19A, 19B/C, 19F, 20, 21, 22A, 22F, 23A, 23B, 23F, 24, 25, 27, 28, 29, 31, 32, 33A, 33F, 33B/C/D, 34, 35, 36, 37, 38, 39, 41 and 47, the serotype-distinguishing antibodies may include a panel of type-specific, factor-specific and group-specific antibodies as defined further herein.

As used herein, “selective” for a given serotype of S. pneumoniae is preferably 5-fold, such as 10-fold or 50-fold higher binding affinity and/or avidity for the given serotype than for other serotypes of S. pneumoniae.

However, in some cases it is not necessary that the serotype-distinguishing antibodies each be selective for only a single serotype of S. pneumoniae, provided that each serotype in a set of serotypes of S. pneumoniae to be detected will bind the array with a unique binding signature. For example, when the set of serotypes of S. pneumoniae to be detected comprises serotypes: 9A, 9L, 9N and 9V, the serotype-distinguishing antibodies may include factor-specific antibodies 9d, 9b, 9e and 9g. In this example factor-specific antibody 9d binds S. pneumoniae serotypes 9A and 9V; factor-specific antibody 9b binds S. pneumoniae serotypes 9L and 9N; factor-specific antibody 9e binds S. pneumoniae serotype 9N; and factor-specific antibody 9g binds S. pneumoniae serotype 9V. The binding signature of each S. pneumoniae serotype is unique (as illustrated by the present example in which, serotype 9A will bind at the location or locations corresponding to factor-specific antibody 9d; serotype 9L will bind at the location or locations corresponding to factor-specific antibody 9b; serotype 9N will bind at the location or locations corresponding to factor-specific antibodies 9b and 9e; and serotype 9V will bind at the location or locations corresponding to factor-specific antibodies 9d and 9g). Thus, S. pneumoniae serotypes can be distinguished using antibodies that cross-react with different S. pneumoniae serotypes to a limited and defined extent, i.e. there is not a one-to-one correlation between the antibodies and the serotypes, because each serotype in a set of serotypes of S. pneumoniae to be detected will bind the array with a unique binding signature.

### Type-Specific Antibodies

The set of capture antibodies may comprise a plurality of type-specific antibodies, each type-specific antibody being selective for a single serotype of S. pneumoniae. Type-specific antibodies may be polyclonal antibodies, for example antisera produced by immunisation of rabbits with individual S. pneumoniae serotype strains. Cross-reactions of the antisera with other serotypes may be eliminated or reduced by absorption. The type-specific antibodies may be selective for serotypes of S. pneumoniae other than those serotypes falling within serogroups. Preferably, the type-specific antibodies are selected from the following type-specific antibodies available from Statens Serum Institut, Copenhagen, Denmark: 1, 2, 3, 4, 5, 8, 13, 14, 20, 21, 27, 29, 31, 34, 36, 37, 38, 39, 40, 42, 43, 44, 45, 46 and 48, each of which is selective for its respective S. pneumoniae serotype.

### Factor-Specific Antibodies

The set of capture antibodies may comprise a plurality factor-specific antibodies, each factor-specific antibody being selective for one or more serotypes of S. pneumoniae of a single S. pneumoniae serotype group. Factor-specific antibodies may be used to distinguish different serotypes from within a serogroup of S. pneumoniae. Factor-specific antibodies may be polyclonal antibodies, for example antisera produced by immunisation of rabbits. Cross-reactions of the antisera within each serogroup may be eliminated or reduced by absorption. Preferably, the factor-specific antibodies are selected from the factor-specific antibodies available from Statens Serum Institut, Copenhagen, Denmark, listed in Table 1 below.

TABLE 1

| Factor-specific antisera | Reacts with S. pneumoniae serotype(s) |
|---|---|
| 6a | 33D |
| 6b | 6A |
| 6c | 6B |
| 7b | 7F, 7A |
| 7c | 7A |
| 7e | 7B |
| 7f | 7C |
| 7h | 19B, 19C |
| 9b | 9L, 9N |
| 9d | 9A, 9V |
| 9e | 9N |
| 9g | 9V |
| 10b | 10F, 10B, 10C |
| 10d | 10A, 10B |
| 10f | 10C |
| 11b | 11F, 11B, 11C, 11D |
| 11c | 11A, 11C, 11D |
| 11f | 11B, 11C |
| 11g | 11F, 11B |
| 12b | 12F, 12B |
| 12c | 12A, 12B |
| 12e | 12B |
| 15b | 15F, 15B |
| 15c | 15F, 15A |
| 15e | 15B, 15C |
| 15h | 15B |
| 16b | 16F |
| 16c | 16A |
| 17b | 17F |
| 17c | 17A |
| 18c | 18F, 18C |
| 18d | 18A |
| 18e | 18F, 18B, 18C |
| 18f | 18F |
| 19b | 19F |
| 19c | 19A |
| 19f | 19C |
| 20b | 33A |
| 22b | 22F |
| 22c | 22A |
| 23b | 23F |
| 23c | 23A |
| 23d | 23B |
| 24c | 24A |
| 24d | 24F, 24A |
| 24e | 24B |
| 25b | 25F |
| 25c | 25A |
| 28b | 28F |
| 28c | 28A |
| 29b | 35B |
| 32a | 32F, 32A |
| 32b | 32A |
| 33b | 33F, 33A |
| 33e | (33F), (33A), 33C |
| 33f | 33B, (33C), 33D |
| 35a | 35F, 35A, 35B, 35C |
| 35b | 35F |
| 35c | 35A, 35B, 35C |
| 41a | 41F, 41A |
| 41b | 41F |
| 42a | 35C |
| 43b | 47A |
| 47a | 47F, 47A |

### Group-Specific Antibodies

The set of capture antibodies may comprise a plurality group-specific antibodies, each group-specific antibody being selective for a single S. pneumoniae serotype group (“serogroup”). Group-specific antibodies may be used to distinguish different serogroups of S. pneumoniae. Group-specific antibodies may be polyclonal antibodies, for example antisera produced by immunisation of rabbits. Cross-reactions of the antisera between serogroups may be eliminated or reduced by absorption. The group-specific antibodies may comprise a combination of factor-specific antibodies covering all serotypes of a particular group in a group-specific antibody composition. Preferably, the group-specific antibodies are selected from the group-specific antibodies available from Statens Serum Institut, Copenhagen, Denmark, listed in table 2 below.

TABLE 2

| | Reacts with |
|---|---|
| Group-specific antisera | S. pneumoniae serotype(s) |
| 6 | 6A, 6B |
| 7 | 7F, 7A, 7B, 7C |
| 9 | 9A, 9L, 9N, 9V |
| 10 | 10F, 10A, 10B, 10C |
| 11 | 11F, 11A, 11B, 11C, 11D |
| 12 | 12F, 12A, 12B |
| 15 | 15F, 15A, 15B, 15C |
| 16 | 16F, 16A |
| 17 | 17F, 17A |
| 18 | 18F, 18A, 18B, 18C |
| 19 | 19F, 19A, 19B, 19C |
| 22 | 22F, 22A |
| 23 | 23F, 23A, 23B |
| 24 | 24F, 24A, 24B |
| 25 | 25F, 25A |
| 28 | 28F, 28A |
| 32 | 32F, 32A |
| 33 | 33F, 33A, 33B, 33C, 33D |
| 35 | 35F, 35A, 35B, 35C |
| 41 | 41F, 41A |
| 47 | 47F, 47A |

### Pooled Antibodies

The set of capture antibodies may comprise a plurality of pooled antibodies, particularly pooled serotype-distinguishing antibodies such as type-specific antibodies, factor-specific antibodies and/or group-specific antibodies as defined herein.

Preferably, the pooled antibodies are selected from the pneumococcal pool antisera available from Statens Serum Institut, Copenhagen, Denmark, listed in table 3 below. These pool antisera comprise 14 different pool sera (A-I, P-T) each reacting with 8-14 serotypes of pneumococci. Pools A to I cover all 90 different types. Pools P to T cover the 21 types and/or groups present in the 23-valent pneumococcal vaccine.

TABLE 3

| Pool antisera | Reacts with S. pneumoniae |
|---|---|
| A | Types 1, 2, 4, 5 |
| | Group 18 |
| B | Types 3, 8 |
| | Groups 6, 19 |
| C | Types 20, 31, 40 |
| | Groups 7, 24 |
| D | Types 36, 37 |
| | Groups 9, 11, 16 |
| E | Types 21, 39 |
| | Groups 10, 12, 33 |
| F | Type 27 |
| | Groups 17, 22, 32, 41 |
| G | Types 29, 34, 42 |
| | Groups 35, 47 |
| H | Types 13, 14 |
| | Groups 15, 23, 28 |
| I | Types 38, 43, 44, 45, 46, 48 |
| | Group 25 |
| P | Types 1, 14 |
| | Groups 7, 19 |
| Q | Groups 6, 18, 23 |
| R | Types 3, 4 |
| | Groups 9, 12 |
| S | Types 5, 8 |
| | Groups 10, 15, 17 |
| T | Types 2, 20 |
| | Groups 11, 22, 33 |

The set of capture antibodies may comprise pooled antibodies in addition to type-specific and/or factor-specific antibodies so as to provide internal control or corroboration of detection of a particular serotype. For example, in some cases the set of capture antibodies may comprise type-specific antibody 1 and pool antibody A, both of which bind S. pneumoniae serotype 1. Thus, serotype 1 S. pneumoniae cells will bind at the array locations corresponding to type-specific antibody 1 and pool antibody A. Detecting binding of S. pneumoniae cells to pool antibody A in addition to type-specific antibody 1 therefore provides internal corroboration of the serotype detected.

### Omniserum

The set of capture antibodies may comprise omniserum which binds all known S. pneumoniae serotypes, i.e. serotypes: 1, 2, 3, 4, 5, 6A, 6B, 6C, 7F, 7A, 7B, 7C, 8, 9A, 9L, 9N, 9V, 10F, 10A, 10B, 10C, 11F, 11A, 11B, 11C, 11D, 12F, 12A, 12B, 13, 14, 15F, 15A, 15B, 15C, 16F, 16A, 17F, 17A, 18F, 18A, 18B, 18C, 19F, 19A, 19B, 19C, 20, 21, 22F, 22A, 23F, 23A, 23B, 24F, 24A, 24B, 25F, 25A, 27, 28F, 28A, 29, 31, 32F, 32A, 33F, 33A, 33B, 33C, 33D, 34, 35F, 35A, 35B, 35C, 36, 37, 38, 39, 40, 41F, 41A, 42, 43, 44, 45, 46, 47F, 47A and 48. The omniserum may be the omniserum available from Statens Serum Institut, Copenhagen, Denmark.

### Anti-C-Polysaccharide Antibody

The set of capture antibodies may comprise an anti-C-polysaccharide antibody capable of binding the cell wall polysaccharide common to all pneumococci. The anti-C-polysaccharide antibody may be the anti-C-polysaccharide serum available from Statens Serum Institut, Copenhagen, Denmark.

### Binding to a Subset of the Set of Capture Antibodies

In accordance with the methods of the invention, in particular methods for identifying one or more serotypes of S. pneumoniae in a sample in accordance with the present invention, S. pneumoniae cells present in the sample are captured selectively by a subset of the set of capture antibodies, which subset corresponds to one or more particular serotypes of S. pneumoniae. The precise subset of capture antibodies which bind a given serotype of S. pneumoniae cells is determined by the antibody array design. The subset may be a single capture antibody of the set of capture antibodies (e.g. a single type-specific antibody that is selective for the serotype present in the sample) or the subset may comprise a plurality of capture antibodies of the set of capture antibodies (e.g. a type-specific antibody and a pooled antibody, both of which bind the serotype present in the sample).

Preferably, the antibody array is subject to one or more wash steps after the contacting the antibody array, but prior to detecting binding of S. pneumoniae cells to a subset of the set of capture antibodies. Washing facilitates removal of unbound cells, thereby increasing the signal-to-noise ratio of the method by reducing background binding. Alternatively or additionally, the antibody array may be contacted with a blocking solution to minimise non-specific binding interactions, thereby also increasing the signal-to-noise ratio of the method.

Preferably the subset of capture antibodies to which S. pneumoniae cells in the sample bind is detected by determining the array position or positions at which the cells are bound. The array positions of the different capture antibodies are pre-determined and thus addressable. Therefore, the positional information of cell binding position or positions indicates the subset of capture antibodies to which the S. pneumoniae cells have bound, thereby indicating the particular serotype or serotypes of S. pneumoniae present in the sample.

In some cases, the user may be provided with a reference, such as a chart, key or database indicating the array position or positions that correspond to each of a set of S. pneumoniae serotypes to be detected. Thus, cell binding position(s) may be readily converted to cell serotype information by consulting the reference.

### Determining Array Positions

In accordance with the methods of the invention, in particular methods for identifying one or more serotypes of S. pneumoniae in a sample in accordance with the present invention, the array position or positions at which S. pneumoniae cells of the sample are bound may be determined by visual inspection, such as microscopic inspection. The determination may involve capture of an image of the antibody array for subsequent analysis.

Preferably, the S. pneumoniae cells will be labelled with at least one detectable label to facilitate determination of the array position or positions at which the cells are bound. The position(s) of the label or labels will therefore indicate the array position of positions at which the labelled cells have bound. The at least one detectable label may be selected from: a fluorescent dye; a labelled antibody capable of binding an antigen present on the surface of an S. pneumoniae cell; a labelled binding agent having affinity for the surface of an S. pneumoniae cell; and/or a visible cell staining agent. The methods and kits of the invention therefore contemplate a single detectable label or any combination of detectable labels described herein (including the following detectable labels defined further below: a fluorescent dye; a labelled antibody capable of binding an antigen present on the surface of an S. pneumoniae cell; a labelled binding agent having affinity for the surface of an S. pneumoniae cell; and/or a visible cell staining agent).

Cell labelling may be performed prior to, at the same time as or after contacting the array with the sample. Labelling of the cells bound to the antibody array (“in situ labelling”) is preferred in some cases, inter alia, in order to minimise the quantity of the detectable label needed (e.g. when the detectable label comprises a relatively expensive fluorophore).

In some cases the at least one detectable label comprises a fluorophore. If multiple fluorophores are employed, they may be conveniently chosen so as to have similar excitation and/or emission wavelengths (e.g. the respective emission wavelengths may be within 10 nm of each other and/or the respective excitation wavelengths may be within 10 nm of each other). This permits a single fluorescence photomicrograph (such as that obtained with a confocal laser microscope) to capture the label positions of all detectable labels without requiring multiple changes of filters and/or laser wavelengths.

### Fluorescent Dye

In certain cases of the methods and kits of the invention described herein said at least one detectable label may be a fluorescent dye. The present inventors have surprisingly found that, despite the polysaccharide capsule surrounding the S. pneumoniae cell, it is possible to label many serotypes of S. pneumoniae with a cell-penetrating fluorescent dye (e.g. a DNA-labelling dye). A preferred fluorescent dye is SYTO 25 (Frey T., 1995) (Molecular Probes, Invitrogen, Carlsbad, Calif., USA).

The present inventors have found that at least the following serotypes of S. pneumoniae are susceptible to labelling with the fluorescent DNA-labelling dye SYTO 25: 1, 2, 4, 5, 6A, 6B, 7A, 7F, 7B/C, 8, 9N, 9V, 9A/L, 10A, 10B, 10C/F, 11A, 11B/C/D/F, 12A, 12B, 12F, 13, 14, 15A, 15B, 15C, 15F, 16A, 16F, 17A, 17F, 18A/B, 18C, 18F, 19A, 19B/C, 19F, 20, 21, 22A, 22F, 23A, 23B, 23F, 24, 25, 27, 28, 29, 31, 32, 33A, 33F, 33B/C/D, 34, 35, 36, 37, 38, 39, 41 and 47. The peculiar properties of the serotype 3 capsule render this serotype substantially impermeable to SYTO 25 under certain conditions described herein. However, in certain preferred embodiments of the method of the invention, the sample is treated so as to render permeable cells of an S. pneumoniae serotype that is not normally permeable. The permeabilising treatment may comprise an alkali treatment, (e.g. exposing the sample to pH in the range of 10-12, preferably around pH 11), an acid treatment (e.g. exposing the sample to pH in the range of 3-5, preferably around pH 4) and/or a sonication treatment (e.g. immersion of the sample in a sonication bath for around 1 minute). The permeabilising treatment is preferably carried out prior to labelling of the sample with a detectable label, such as a cell-penetrating fluorescent dye. It has been found that such permeabilising treatments allow serotype 3 S. pneumoniae cells to be labelled with SYTO 25.

### Labelled Antibody

In certain cases of the methods and kits of the invention described herein said at least one detectable label may be a labelled antibody. The labelled antibody may be any antibody (including monoclonal, polyclonal and antisera) that is capable of binding an antigen present on the surface of at least one serotype of S. pneumoniae. Preferably, the antibody is capable of binding all serotypes of S. pneumoniae under consideration. The labelled antibody comprises an antibody coupled to a detectable moiety. The detectable moiety may be coupled to the antibody by covalent linkage or by a high affinity binding interaction, for example the detectable label may be coupled to the antibody via a streptavidin-biotin linkage. The detectable moiety may be a fluorophore as defined herein. In particular, the labelled antibody may comprise an antibody linked to phycoerythrin. The labelled antibody may be directly labelled, e.g. labelled with an Alexa fluorophore such as Alexa-647. Alternatively, the detectable moiety may comprise a chromogen. For example, the labelled antibody may be coupled to horseradish peroxidase for generation of a pigmented precipitate from a suitable substrate (e.g. tetramethylbenzidine or a derivative thereof) under appropriate conditions.

### Labelled Binding Agent

In certain cases of the methods and kits of the invention described herein said at least one detectable label may be a labelled binding agent. The labelled binding agent may be a labelled molecule other than an antibody, which molecule has high affinity for the surface (e.g. the capsule) of S. pneumoniae. The labelled binding agent may be a protein (such as a polypeptide ligand or receptor) or a polysaccharide. The labelled binding agent may be coupled to a fluorophore as defined herein.

### Visible Cell Staining Agent

In certain cases of the methods and kits of the invention described herein said at least one detectable label may be a visible cell staining agent. The visible cell staining agent may be any agent that increases the visibility of S. pneumoniae cells under an optical microscope. Preferably, the visible cell staining agent is a Gram stain. The use of a visible staining agent avoids the need for relatively expensive fluorescence detection equipment.

### Combination Labelling

In certain cases of the methods of the invention described herein may comprise use of more than one detectable label. This is advantageous when one detectable label is unable to or has limited ability to label all serotypes of S. pneumoniae under consideration. The use of complementary detectable labels may be employed in order to label all serotypes of S. pneumoniae under consideration. Therefore, the methods of the present invention address the hitherto unappreciated difficulties in labelling S. pneumoniae cells of a wide variety of serotypes.

In some cases, the at least one detectable label comprises a fluorescent dye as defined herein and a labelled antibody as defined herein. The labelled antibody may be capable of binding an antigen present on the surface of at least one serotype of S. pneumoniae that is substantially impermeable to the fluorescent dye. For example, the at least one detectable label may comprise SYTO 25 and a labelled antibody (e.g. a phycoerythrin-labelled or an Alexa-antibody) that is capable of binding an antigen present on the surface of serotype 3 of S. pneumoniae.

### PneumoArray Software

The software provides an easier interpretation for the serotyping data since a complex matrix of 484 points has to be analysed and interpreted by the user. Thus, use of suitable software reduces time and effort associated with visually analysis performed by the user. Furthermore, the software allows traceability of the analysed samples (registration of data spreadsheet and word processed files) and may have incorporated the rules and algorithms necessary to discriminate between specific and non-specific binding events thereby avoiding mistakes in serotype determination (miss-typing).

Briefly, in certain embodiments the fluorescence emitted by the fluorophore or fluorophores in the chip is read by a scanner at 532 nm (first channel) and at 632 nm (second channel required only for the serotype 3 detection using the sandwich approach). Once the image is shown in the screen the software of the scanner (Mapix software for Innopsys scanner and Genepix software for Axon scanner) allows quantification of signal intensities of all the spots present in the chip that will correspond to each location of the printed antisera. A text file is then generated with all the fluorescence intensity data. Thereafter, the text file serves as the input file for the PneumoArray software and it is loaded for the serotype determination. Each well is then identified by the user with its corresponding sample code, thereby permitting traceability of the analysed samples in the chip. The software then provides an output file wherein the serotypes are determined according to specific rules and algorithms that are based on the specific binding of bacteria to the corresponding factor, type or group antisera. For each specific factor, type or group binding, a threshold value of fluorescence is predicted by the software, thus allowing discrimination of specific from non-specific bacteria-antiserum binding events.

### Kits

The kit for serotyping S. pneumoniae in accordance with the invention comprises one or more antibody arrays of the invention together (e.g. an antibody microarray as described herein) with one or more reagents, controls and/or standards. The one or more reagents may include buffers, such as washing buffers or incubation buffers, labelling means such as a fluorescent dye (which may be in solution or provided in solid form for dilution), labelled antibodies, labelled binding agents and/or visible cell staining agents. The one or more controls or standards may include a particular defined serotype or serotypes of S. pneumoniae to act as a positive control in a serotyping assay in accordance with the methods of the invention. Optionally, the kit may comprise printed packaging and/or a printed insert containing instructions for performing a serotyping assay in accordance with the methods of the invention. Optionally, the kit may comprise computer readable media having stored thereon a computer program capable of analysing an array read-out, thereby facilitating serotyping of a sample.

The following is presented by way of example and is not to be construed as a limitation to the scope of the claims.

### EXAMPLES

### Example 1

### Growth of S. pneumoniae Bacteria

Streptococcus pneumoniae strains were isolated from clinical samples (hemoculture samples) using enriched growth media for this bacteria as indicated in standard clinical protocols. After testing positive in the optoquin-sensitivity test (Bowen, 1957), the isolates were picked and cultured on plates containing blood agar, grown overnight at 37° C. with 5% CO₂. After a minimum of 16 h, one aliquot from each plate was pelleted by centrifugation, washed with TBS buffer and resuspended in TBS buffer for serotyping using microarray chip (as described further herein). The remainder of the bacterial sample was stored at −80° C. Alternatively, liquid cultures were also performed from the isolates by inoculating an aliquot of each strain into a tube containing 3 mL of Todd-Hewitt growth medium (CM0189, Oxoid, Hampshire, UK) enriched with 0.5% Yeast extract (LP0021, Oxoid).

### Microarray Production

Factor, type, group and pool antisera and omniserum for the serotyping of S. pneumoniae were obtained from Statens Serum Institute, Copenhagen, Denmark. The factor and type antisera contain S. pneumoniae strain-specific polyclonal antibodies. The antisera were raised in rabbits under aseptic conditions. Cross reactions in pool, type and group antisera are removed by absorption. In the case of factor antisera, cross reactions with the group are removed by absorption. Production of antisera and reduction or elimination of cross-reaction by absorption has been described previously (Lund and Henrichsen, 1978; the disclosure of which is incorporated herein by reference in its entirety).

Briefly, a well-characterised strain of S. pneumoniae is used to inoculate a trypsin broth. Growth is stopped by addition of formalin to a concentration of 2%, after subcultures from each flask have been made onto blood agar plates as a control of purity. The cultures are centrifuged, the supernatant discarded and the sediment is ground in a mortar and resuspended in Sorensen buffer solution with 0.5% formalin. The vaccine may be checked with a capsular reaction using the homologous serum and a Gram-stain performed. The vaccine is used to immunise white rabbits by injection using a suitable immunisation protocol (e.g. 4-5 weeks, several injections per week). At the conclusion of the immunisation the animals are bled out. Capsular and agglutination titres of each serum obtained are determined. The degree of cross-reaction is assessed by titration, and eliminated by absorption carried out with dense formolised vaccines. The vaccine is centrifuged and the sediment mixed thoroughly with the serum to be absorbed. The absorption is typically completed within 5-10 min. The mixture of serum and vaccine is centrifuged and the clear supernatant serum is tested for capsular reaction with the absorbing type to ensure that absorption has left no residual cross-reactivity.

The factor, type, group, pool antisera A-I and omniserum (all obtained from Statens Serum Institute, Copenhagen, Denmark) were immobilised as capture agents on the microarray surface. The printing procedure was performed as follows. Type, factor and group sera were diluted in printing buffer and 4 serial dilutions were prepared. Pool sera and omniserum were also printed in duplicate but in 3 serial dilutions. The different dilutions were added into wells of the source plate (384-microwell plate, Genetix, Hampshire, UK) according to the microarray layout design (see FIG. 1). A contact printer device (Microgrid II 610, Biorobotics, Genomic Solutions Inc., Ann Arbor, Mich., USA) was used to print the solutions per well on epoxy-coated multi-well slides (Nexterion MPX16 and barcoded MPX12, Schott, Jena, Germany) for each factor, type, group, pool serum and omniserum. These multi-well slides allow the simultaneous analysis of 12 samples (barcoded slides) or 16 samples. Using 2 split pins, the printer delivered approximately 10 nL of sera to the slides, yielding 140 μm-diameter spots at 240 μm centre-to-centre spacing. Each pin printed a total of 16 spots per each source visit, covering the 8-well column on a slide. A pattern of 361 spots was generated per well (19 columns×19 rows). Serum bovine albumin (BSA) was printed in 8 points at 0.5 mg/mL in printing buffer as control for non-specific binding. Printing buffer was also printed in 8 spots as negative control. A pattern containing 37 spots of streptavidin-Cy3 was printed at 5 μg/mL as grid anchor points for subsequent imaging of the microarray (see FIG. 1).

The microarray described in the present examples (the layout of which is depicted in FIG. 1) is conveniently referred to herein as the “PneumoChip-23 Microarray” or “PneumoArray-23”. The 361-element array comprises a 4-element capture dilution series printed in duplicate for each factor (6b, 6c, 7b, 9e, 9g, 10b, 10d, 11b, 11c, 11f, 12b, 12e, 15h, 17b, 18c, 18f, 19b, 19c, 22b, 23b, 33b and 20b), type (1, 2, 3, 4, 5, 8, 14 and 20) and group serum (6) and also a 3-element capture dilution series in duplicate for each pool serum (from pool A to pool I) and omniserum (OMS). In addition, controls were also printed: BSA and printing buffer as negative controls and streptevidin-Cy3 (Cy3) as anchorage point for the grid. The PneumoChip-23 Microarray is thus configured for identification of 23 (and optionally 24) different S. pneumoniae serotypes: 1, 2, 4, 5, 6A, 6B, 7F, 8, 9N, 9V, 10A, 11A, 12F, 14, 15B, 17F, 18C, 19A, 19F, 20, 22F, 23F and 33F and optionally serotype 3.

### Processing of the PneumoChip-23 Microarray

All the steps of microarray incubation were performed during shaking on a horizontal shaker and at room temperature. A vacuum system was adapted with a tube coupled with a pipette pin to aspirate liquid from the wells and a multi-channel pipette was used to add the solutions required for developing the chip. Once prepared, and before incubation, the slides were scanned at high laser power (excitation wavelength of 532 nm and the emission filtered at 575 nm) as an internal quality control to ensure that all the spots were printed on the well surface. Gasket superstructures were stuck on the slides to limit the area of the 14 wells, when barcoded slides were used, or 16 wells for standard MPX16 slides. The wells were blocked in 100 μL of blocking solution for a minimum of 30 min. The blocking solution was removed and 50 μL of the bacterial sample was added to each well and incubated for 15 min. Three washing steps of 2 min each were performed to remove the unlabeled bacteria and the labelling was performed on the chip by adding the fluorescent dye SYTO 25 (Frey T., 1995) (Molecular Probes, Invitrogen, Carlsbad, Calif., USA) at 20 μM for 15 min. The labelling solution was aspirated and the gasket superstructure was removed. Then the slide was gently washed three times in washing buffer (2 min each washing step). Finally, the slide was washed twice in distilled H₂O (1 min each wash) while being vigorously shaken, then dried by centrifugation (5 min at 500×g).

The slide was then read using a chip scanner (Axon Scanner GenePix 4100A, Molecular Devices, Sunnyvale, Calif., USA) at an excitation wavelength of 532 nm and the emission filtered at 575 nm. The laser power was adjusted depending on the fluorescent signal detected from the spots. The software package Genepix 6.0 (Molecular Devices) was used for the microarray image analysis. A grid was set up to define the positions of all the spotted capture sera (factor sera, type sera, group sera, pool sera and omniserum) in order to identify the serotype-specific signal of the microarray (in this case the PneumoChip-23 Microarray).

Serotyping of S. pneumoniae

Bacterial strains of S. pneumoniae were isolated from patient samples (hemocultures) and stored at −20° C. until use. These samples were used as reference samples for the typing of the 23 serotypes using the PneumoChip-23 Microarray: 1, 2, 4, 5, 6A, 6B, 7F, 8, 9N, 9V, 10A, 11A, 12F, 14, 15B, 17F, 18C, 19A, 19F, 20, 22F, 23F and 33F. Table 1 shows the reactivity of the printed probes included in the chip with the different serotypes. Specific antisera were included as factor and type sera along with a group serum (serotype 6 positive for 6A and 6B strains), sera pools (from A to I) and the omniserum. Note that antiserum 3 is not included in the list but was included when a sandwich method was used for its serotyping (see Example 2 below).

TABLE 4
Antisera serotype reactivity

| | Reacts with S. pneumoniae |
|---|---|
| Pool | |
| A | Types 1, 2, 4, 5; Group 18 |
| B | Types 3, 8; Group 6, 19 |
| C | Types 20, 31, 40; Group 7, 24 |
| D | Types 36, 37; Group 9, 11, 16 |
| E | Types 21, 39; Group 10, 12, 33 |
| F | Types 27; Group 17, 22, 32, 41 |
| G | Types 29, 34, 42; Group 35, 47 |
| H | Types 13, 14; Group 15, 23, 28 |
| I | Types 38, 43, 44, 45, 46, 48; Group 25 |
| Type | |
| 1 | 1 |
| 2 | 2 |
| 3 | 3 |
| 4 | 4 |
| 5 | 5 |
| 8 | 8 |
| 14 | 14 |
| 20 | 20 |
| Group | |
| 6 | 6A, 6B |
| Factor | |
| 6b | 6A |
| 6c | 6B |
| 7b | 7F, 7A |
| 7c | 7A |
| 9e | 9N |
| 9g | 9V |
| 10b | 10F, 10, B, 10C |
| 10d | 10A, 10B |
| 11b | 11F, 11B, 11C, 11D |
| 11c | 11A, 11C, 11D |
| 11f | 11B, 11C |
| 12b | 12F, 12B |
| 12e | 12A, 12B |
| 15h | 15B |
| 17b | 17F |
| 18c | 18F, 18C |
| 18f | 18C |
| 19b | 19F |
| 19c | 19A |
| 20b | 33A |
| 22b | 22F |
| 23b | 23F |
| 33b | 33F, 33A |

The peculiar properties of the capsule structure of S. pneumoniae serotype 3 did not allow the penetration of the fluorophore (SYTO 25) inside cells to label the bacterial DNA. Serotype 3 was, therefore, excluded from this example. A modified detection method, incorporating sandwich detection of serotype 3 S. pneumoniae cells, is described in Example 2 below.

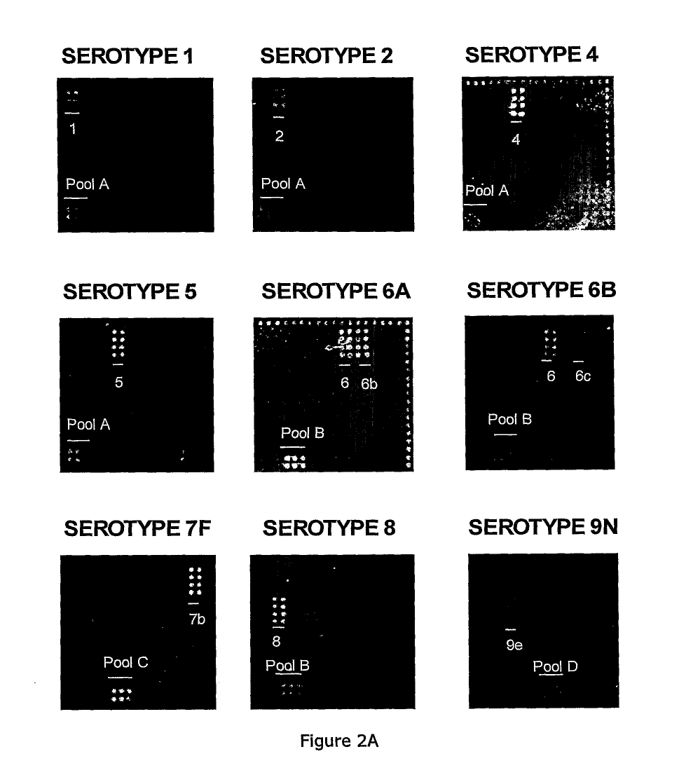

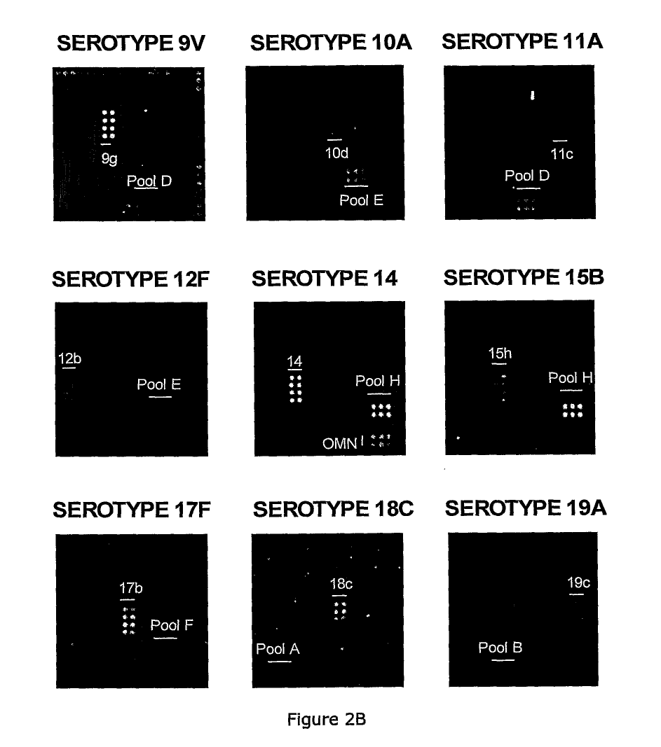

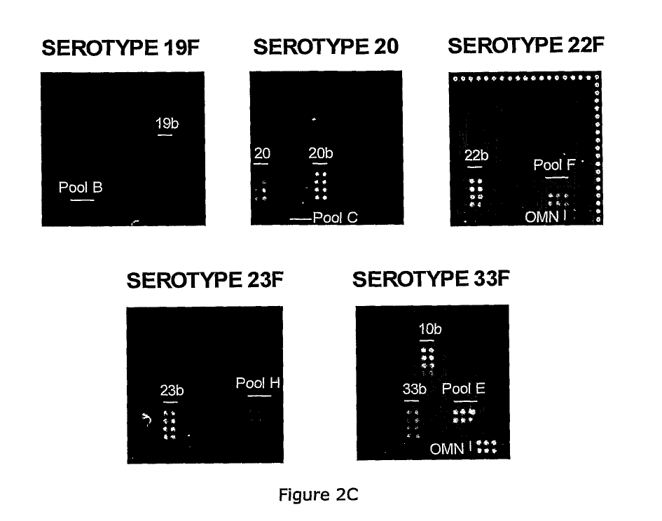

As shown in FIG. 2, fluorescence images of labelled S. pneumoniae cells captured on the PneumoChip-23 Microarray were obtained for serotyping of the 23 serotypes of S. pneumoniae. The wells of the slide are highlighted containing a total number of 361 spots. After scanning the slides, the image analysis grid was anchored and adjusted to the printed streptavidin-Cy3 reference spots (upper row and right column).

Fluorescent signal was detected in the printed eight spots containing four dilutions in duplicate of the specific capture antisera, either factor or type sera in each case. Serotypes could be unequivocally identified by distinguishing the specific signal from the background of the well. In the case of serotypes 6A and 6B, the specific signal was obtained in antisera 6b and 6c respectively, and in addition in the group serum 6 in both cases, allowing their unequivocal identification. In some strains, a certain level of non-specificity or higher background was detected in the spots containing the antisera, as occurred with bacterial serotypes 6A, 8 and 14. The printed pool sera A-I on the microarray were intended to serve as a positive control of the specific signal detected for each serotype and thus used to validate the serotyping. The printed negative controls work properly in all the cases tested, since no signal was detected either in the spots containing BSA or in the spots printed with buffer alone.

In some cases a certain amount of cross-reactivity is observed between e.g. particular type-specific or factor-specific antibodies. However, the signal signature is resolvable allowing discrimination of the serotypes, the observed level of cross-reactivity notwithstanding. For example, bacterial serotype 33F in some cases exhibits a degree of positive signal for factor-specific antibody 10b. A similar situation arises in respect of serotype 20, which exhibits cross-reactivity with antiserum 20b (specific for 33A). This can be explained due to cross-reactivity that is also present in the Quellung reaction for some strains.

In order to assess the specificity of the S. pneumoniae serotyping, other non-pneumococcal streptococcal strains were incubated in the PneumoChip-23 Microarray, such as S. viridans, S. oralis and S. bovis. No fluorescent signal was detected with either the serotype-specific antisera or in the pool anti-sera on the microarray.

### Example 2

### Serotyping of Strain 3 Using a Sandwich Method

Labelling of group serum 3 with biotin and streptavidin-phycoerythrin: Biotin-XX (Invitrogen) was used to label the IgGs contained in the type serum 3. Biotin-XX was dissolved in DMF (Fluke, Sigma-Aldrich, St. Louis, Mo., USA) at 15 mM, aliquots were made and stored at −80° C. until use. Protein content in type serum 3 was quantified using Bradford method. The labelling was performed as follows: 45 μL of antiserum was mixed with 5 μL of carbonate buffer 100 mM, pH 9.4, and the corresponding amount of biotin-XX was added to the mixture. The mixture was incubated for 30 min at room temperature. Meanwhile a column for gel filtration was prepared. Bio-Gel P6 Fine slurry (Bio-Rad) was hydrated in PBS (Sigma-Aldrich) according to the manufacturer's instructions, homogenized and a mini-spin column was prepared (Nanosep MF 0.2 um, Pall Corp., NY, USA). The mini-spin column was centrifuged for 15 s and PBS was removed. The labelling mixture was applied to the mini-spin column and centrifuged for 1 min at 16,000×g. The filtrate, containing the biotin-labelled IgGs in the type serum 3 was diluted in PBS and incubated with PBS-diluted streptavidin-phycoerythrin (Invitrogen) for 15 min in order to allow biotin-streptavidin binding to occur.

Slide preparation, blocking, S. pneumoniae bacteria incubation and washes were performed as described in Example 1 above. An additional second incubation was then performed after adding 50 μL of type serum 3 labelled with biotin-streptavidin-phycoerythrin complex for 20 min for the detection of serotype 3. Then, the antibody solution was removed.

The washing, drying and scanning steps were then performed as described in Example 1 above.

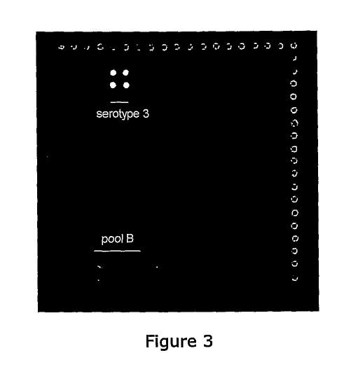

As shown in FIG. 3, the signal obtained for serotype 3 of S. pneumoniae was positive for type 3 and pool B. These results demonstrate that a combination of labelling of S. pneumoniae bacterial cells (serotypes 1, 2, 4, 5, 6A, 6B, 7F, 8, 9N, 9V, 10A, 11A, 12F, 14, 15B, 17F, 18C, 19A, 19F, 20, 22F, 23F and 33F) with a fluorescent dye, and labelling of S. pneumoniae serotype 3 with an antisera-biotin-streptavidin-phycoerythrin conjugate, permit unambiguous identification of the 23 specified serotypes.

### Example 3

### Growth of S. pneumoniae Bacteria

Streptococcus pneumoniae strains were isolated from clinical samples (hemoculture samples) using enriched growth media for this bacteria as indicated in standard clinical protocols. After testing positive in the optoquin-sensitivity test (Bowen, 1957), the isolates were picked and cultured on plates containing blood agar, grown overnight at 37° C. with 5% CO₂. After a minimum of 16 h, bacteria were collected in a single pass using an inoculating loop of 1 μL and resuspended in 200 μL of TBST-T-BSA 5% buffer (Labelling Buffer) for serotyping using microarray chip (as described further herein). The remainder of the bacterial sample was stored at −80° C. Alternatively, liquid cultures were also performed from the isolates by inoculating an aliquot of each strain into a tube containing 3 mL of Todd-Hewitt growth medium (CM0189, Oxoid, Hampshire, UK) enriched with 0.5% Yeast extract (LP0021, Oxoid). As labelling reagent SYTO 25 at 20 μM in DMSO was used (see below). The washing buffer was TBS.

### Microarray Production

Factor, type and group antisera for the serotyping of S. pneumoniae were obtained from Statens Serum Institute, Copenhagen, Denmark. The factor, type and group antisera contain S. pneumoniae strain-specific polyclonal antibodies. The antisera were raised in rabbits under aseptic conditions. Cross reactions in type and group antisera are removed by absorption. In the case of factor antisera, cross reactions with the group are removed by absorption. Production of antisera and reduction or elimination of cross-reaction by absorption has been described previously (Lund and Henrichsen, 1978; the disclosure of which is incorporated herein by reference in its entirety). Details of antisera production are as above for Example 1.

The factor, type and group antisera (all obtained from Statens Serum Institute, Copenhagen, Denmark) were immobilised as capture agents on the microarray surface. The printing procedure was performed as follows. Type, factor and group sera were diluted in printing buffer The different dilutions were added into wells of the source plate according to the microarray layout design. A contact printer device (Microgrid II 610, Biorobotics, Genomic Solutions Inc., Ann Arbor, Mich., USA) was used to print the solutions per well on epoxy-coated multi-well slides (Nexterion MPX16 and barcoded MPX12, Schott, Jena, Germany) for each factor, type and group serum. These multi-well slides allow the simultaneous analysis of 12 samples (barcoded slides) or 16 samples. Using 2 split pins, the printer delivered approximately 10 mL of sera to the slides, yielding 140 μm-diameter spots at 240 μm centre-to-centre spacing. Each pin printed a total of 16 spots per each source visit, covering the 8-well column or E-well column on MPX16 or barcoded-MPX12 slides, respectively. A pattern of 484 spots was generated per well (22 columns×22 rows; see FIG. 4). Printing buffer was also printed in 16 spots as negative control. A pattern containing 30 spots of streptavidin-Cy3 was printed at 5 μg/mL as grid anchor points for subsequent imaging of the microarray (see FIG. 4).

The microarray described in the present examples (the layout of which is depicted in FIG. 4) is conveniently referred to herein as the “PneumoArray”. The 484-element array comprises a 6-element capture series (replicates) printed for each factor (6b, 6c, 7b, 7c, 9e, 9g, 10b, 10d, 11b, 11c, 11f, 12b, 12e, 15b, 15c, 15h, 16b, 17b, 18c, 18f, 19b, 19c, 7h, 22b, 23b, 23c, 33b and 20b), type (1, 2, 3, 4, 5, 8, 13, 14, 20, 21, 27, 29, 31, 34, 36, 37, 38 and 39) and group serum (6, 7, 9, 10, 11, 12, 15, 16, 17, 18, 19, 20, 22, 23, 24, 25, 28, 32, 33, 35, 41 and 47). In addition, controls were also printed: printing buffer as negative control and streptevidin-Cy3 (S-Cy3) as anchorage point for the grid. The PneumoArray is thus configured for identification of 83 different S. pneumoniae serotypes at different information level: 18 at type level (1, 2, 4, 5, 8, 13, 14, 20, 21, 27, 29, 31, 34, 36, 37, 38 and 39, and optionally serotype 3), 31 at factor level (6A, 6B, 7A, 7F, 9N, 9V, 10A, 10B, 11A, 12A, 12B, 12F, 15A, 15B, 15C, 15F, 16A, 16F, 17A, 17F, 18C, 18F, 19A, 19F, 22A, 22F, 23A, 23B, 23F, 33A, 33F), 17 at group level (included in serogroups 24, 25, 28, 32, 35, 41 and 47) and 17 at partial group level (7B/C, 9A/L, 10C/F, 11B/C/D/F, 18A/B, 19B/C and 33B/C/D).

### Processing of the PneumoArray

All the steps of microarray incubation were performed at room temperature. A multi-channel pipette was used to add and remove the solutions required for developing the chip. Once prepared, and before incubation, the slides were scanned at high laser power (excitation wavelength of 532 nm and the emission filtered at 575 nm) as an internal quality control to ensure that all the spots were printed on the well surface. Gasket superstructures were stuck on the slides to limit the area of the 12 wells, when barcoded slides were used, or 16 wells for standard MPX16 slides. The blocking step was performed simultaneously to the incubation step since bacteria were resuspended in a buffer containing BSA 5%. Samples with resuspended bacteria (30 μL from the 200 μL previously prepared) were mixed with 30 μL of the fluorescent dye SYTO 25 (Frey T., 1995) (Molecular Probes, Invitrogen, Carlsbad, Calif., USA) at 20 μM and 50 μL of that mixture were added to each well and incubated for 10 min. The samples were removed and a washing step was performed to remove the unbound bacteria by adding and removing 100 uL of TBS-T buffer (Washing Buffer). Then the gasket superstructure was removed and the entire chip was washed two times (for 15 s and 10 min, respectively) by soaking it in TBS-T buffer (Washing Buffer) under vigorous shaking. Then the chip was dried by centrifugation (5 min at 500×g).

The slide was then read using a chip scanner (Axon Scanner GenePix 4100A, Molecular Devices, Sunnyvale, Calif., USA) at an excitation wavelength of 532 nm and the emission filtered at 575 nm. The laser power was adjusted depending on the fluorescent signal detected from the spots. The software packages Genepix 6.0 (Molecular Devices) and Mapix 2.8.1 (Innopsys) were used for the microarray image analysis. A grid was set up to define the positions of all the spotted capture sera (factor sera, type sera, group sera, pool sera and omniserum) in order to identify the serotype-specific signal of the microarray (in this case the PneumoArray).

Serotyping of S. pneumoniae

Bacterial strains of S. pneumoniae were isolated from patient samples (hemocultures) and stored at −20° C. until use. These samples were used as reference samples for the typing of the 83 serotypes using the PneumoArray: 18 at type level (1, 2, 3, 4, 5, 8, 13, 14, 20, 21, 27, 29, 31, 34, 36, 37, 38 and 39), 31 at factor level (6A, 6B, 7A, 7F, 9N, 9V, 10A, 10B, 11A, 12A, 12B, 12F, 15A, 15B, 15C, 15F, 16A, 16F, 17A, 17F, 18C, 18F, 19A, 19F, 22A, 22F, 23A, 23B, 23F, 33A, 33F), 17 at group level (included in serogroups 24, 25, 28, 32, 35, 41 and 47) and 17 at partial group level (7B/C, 9A/L, 10C/F, 11B/C/D/F, 18A/B, 19B/C and 33B/C/D). Tables 1, 2 and 3 shown herein above indicate the reactivity of the printed probes included in the chip with the different serotypes. Specific antisera were included as factor and type sera along with group sera.

The peculiar properties of the capsule structure of S. pneumoniae serotype 3 did not allow the penetration of the fluorophore (SYTO 25) inside cells to label the bacterial DNA. Serotype 3 was, therefore, excluded from this example. A modified detection method, incorporating sandwich detection of serotype 3 S. pneumoniae cells, is described in Example 4 below. Further modified methods, incorporating pre-treatment (e.g. alkali treatment, acid treatment and/or sonication) of serotype 3 cells are described below in Example 5.

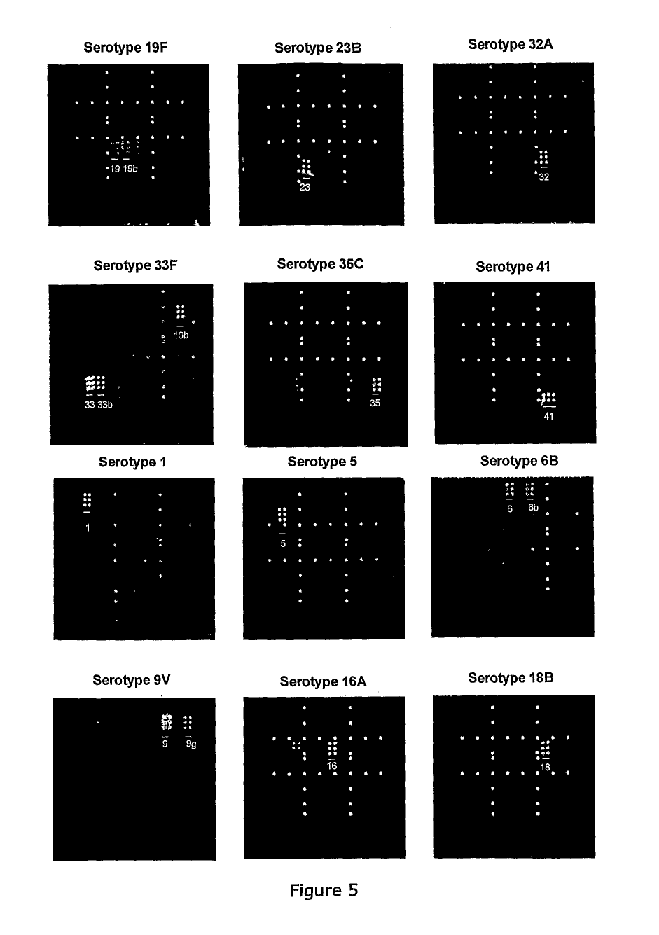

As shown in FIG. 5, fluorescence images of labelled S. pneumoniae cells captured on the PneumoArray were obtained for serotyping of some of the serotypes of S. pneumoniae. The wells of the slide are highlighted containing a total number of 484 spots. After scanning the slides, the image analysis grid was anchored and adjusted to the printed streptavidin-Cy3 reference spots.

Fluorescent signal was detected in the printed six spots containing replicates of the specific capture antisera, either factor, type or group sera in each case. Serotypes could be unequivocally identified by distinguishing the specific signal from the background of the well. As a representative example, for serotypes 6A and 6B, the specific signal was obtained in antisera 6b and 6c respectively, and in addition in the group serum 6 in both cases, allowing their unequivocal identification.

In some cases a certain amount of cross-reactivity is observed between e.g. particular type-specific or factor-specific antibodies. However, the signal signature is resolvable allowing discrimination of the serotypes, the observed level of cross-reactivity notwithstanding. For example, bacterial serotype 33F in some cases exhibits a degree of positive signal for factor-specific antibody 10b. A similar situation arises in respect of serotype 35C, which exhibits cross-reactivity with antiserum 20b (specific for 33A). This can be explained due to cross-reactivity that is also present in the Quellung reaction for some strains.

In order to assess the specificity of the S. pneumoniae serotyping, other non-pneumococcal streptococcal strains were incubated in the PneumoArray, such as S. viridans, S. oralis and S. bovis. No fluorescent signal was detected in specific antisera on the microarray.

### Example 4

### Serotyping of Strain 3 Using a Sandwich Method

Labelling of serotype 3 with Alexa-647: Alexa 647 Monoclonal Antibody Labelling kit (Molecular Probes, Invitrogen) was used to label the IgGs contained in serotype 3. Protein content serotype 3 was quantified using Bradford method. The labelling was performed as follows: antiserum was mixed with a carbonate buffer 100 mM, pH 9.4, and the mixture was added to the vial containing the fluorophore. The mixture was incubated for 1 h at room temperature. Meanwhile a mini-spin column for gel filtration was prepared according to the manufacturer's instructions. The labelling mixture was applied to the mini-spin column and centrifuged for 5 min at 1,100×g. The filtrate, containing the Alexa-647-labelled IgGs in the type serum 3 was collected and the mini-spin column was discarded.

Slide preparation, blocking, S. pneumoniae bacteria incubation and washes were performed as described in Example 3 above with certain modifications. After incubation of the sample on the chip, the solution was removed and a washing step was included to remove any residual bacteria. An additional second incubation was then performed for 10 min with the Alexa-647 labelled anti-serotype 3 antibody. The washing and drying steps were then performed as described in Example 3 above.

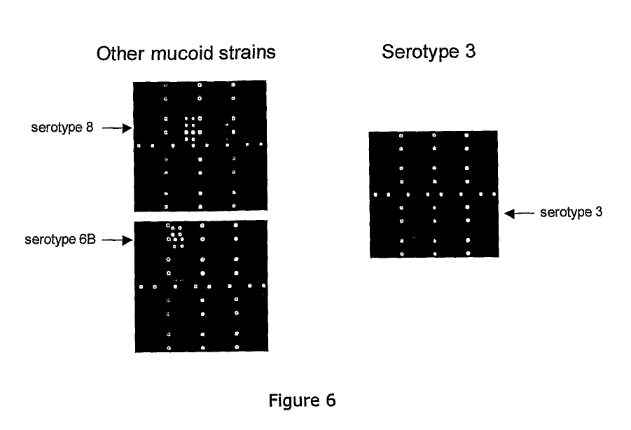

The slide was then scanned as described above at an excitation wavelength of 532 nm and at 635 nm and the data exported to PneumoArray-specific software. The serotype was then determined depending on the detected signal intensities. Using data at 532 nm (emission of the fluorophore) the software determined the serotype of all the samples except for the incubated serotype 3; using data at 635 nm (emission of the labelled anti-serotype antibody) the software detected specifically the presence of serotype 3. Although serotype 3 can be visually identified in the plate due to its mucoid aspect, it is important to differentiate type 3 from that of other mucoid strains, such as rare strains of serotypes 6A, 8, and 35. As shown in FIG. 6, analysis of the S. pneumoniae sample was positive for serotype 3 (635 nm) as well as serotype 8 and serotype 6B (532 nm). These results demonstrate that a combination of labelling of S. pneumoniae bacterial cells (serotypes 1, 2, 4, 5, 6A, 6B, 7F, 8, 9N, 9V, 10A, 11A, 12F, 14, 15B, 17F, 18C, 19A, 19F, 20, 22F, 23F and 33F) with a fluorescent dye, and labelling of S. pneumoniae serotype 3 with an Alexa-647 labelled conjugate, permit unambiguous identification of the 23 specified serotypes.

### Example 5

### Serotyping of Strain 3 Using Single Fluorophore Detection

In some embodiments of the invention it will be advantageous to detect serotype 3 in the same channel as the rest of the serotypes, e.g. at 532 nm. Therefore, in some embodiments the bacteria to be tested for serotype 3 will be pre-treated so as to render the serotype 3 bacteria permeable to one or more detectable labels, e.g. SYTO 25. In this way suitably treated serotype 3 bacteria may be detected using the same detectable label as other serotypes, minimising or eliminating the need for complementary labelling, and thereby providing in many cases reduction in cost and/or resources required for serotyping. Preferred treatments of the serotype 3 bacteria include an alkali treatment step, an acid treatment step and/or a sonication step. The treatment may comprise disruption of the capsule.

### Serotype 3 Detection by Acid Treatment

The bacteria are harvested from the plates using an inoculating loop as described above and resuspended in 200 μL of a 20 mM sodium acetate buffer at pH 4. The sample is incubated at 37° C. for 30 min and thereafter the tube is centrifuged, the supernatant removed using a pipette and the pellet resuspended in 200 μL of TBST-BSA 5% (Labelling Buffer). Then the protocol as described in Example 3 is applied to detect serotype 3: labelling with SYTO 25 fluorophore, incubation in chip and binding detection by reading fluorescence at 532 nm.

### Serotype 3 Detection by Sonication

In this case the bacteria are harvested from the blood-agar plate and resuspended in 200 μL of TBST-BSA 5% (Labelling Buffer) as described in Example 3 for all the serotypes. A sonication step is included to disrupt the bacterial surface. The tube containing resuspended bacteria is immersed in a sonication bath for 1 min. After that the standard procedure is applied to detect serotype 3: labelling with SYTO 25 fluorophore, incubation in chip and binding detection by reading fluorescence at 532 nm. Alternatively, the sonication step will be performed after the addition of the SYTO 25 fluorophore, as follows: after preparing the mixture of bacteria (30 μL) with fluorophore SYTO 25 (30 μL), as described in Example 3, the tube is then sonicated for 1 min and then incubated in the chip.

### Serotype 3 Detection by Alkali Treatment

The bacteria are harvested from the plates using an inoculating loop as described above and they are resuspended in 200 μL of an alkali buffer containing NaOH 0.01 N, at pH 11. The sample is incubated at 37° C. for 15 min and thereafter the tube is centrifuged, the supernatant removed using a pipette and the pellet resuspended in 200 μL of TBST-BSA 5% (Labelling Buffer). The protocol as described in Example 3 is applied to detect serotype 3: labelling with SYTO 25 fluorophore, incubation in chip and binding detection by reading fluorescence at 532 nm.

Alkali treatment was found to be very effective, significantly enhancing signal detection of the fluorophore. It is presently believed that the alkali treatment speeds hydrolysis of the pneumococcal polysaccharide, being more effective in this regard than acidic treatment (Brown and Robinson, 1944).

All references cited herein are incorporated herein by reference in their entirety and for all purposes to the same extent as if each individual publication or patent or patent application was specifically and individually indicated to be incorporated by reference in its entirety.

The specific embodiments described herein are offered by way of example, not by way of limitation. Any sub-titles herein are included for convenience only, and are not to be construed as limiting the disclosure in any way.

### REFERENCES

Musher, D. M. Streptococcus pneumoniae. In: Mandell G L, Bennett J E, Dolin R, eds. Principles and practice of infectious diseases. 5th ed. New York: Churchill Livingstone 2000:2128-2147.
Henrichsen, J. 1995. J. Clin. Microbial. 33:2759-2762.
Dagan, R., R. Melamed, O. Zamir, and O. Leroy. 1997. Pediatr, Infect. Dis, J. 16:1053-1059.
Perez-Trallero, E., C. Garcia-de-la-Fuente, C. Garcia-Rey, F. Baquero, L. Aguilar, R. Dal-Re, J. Garcia-de-Lomas, and Spanish Surveillance Group for Respiratory Pathogens. 2005. Antimicrob. Agents Chemother. 49:1965-1972.
Brueggemann, A. B., T. E. Peto, D. W. Crook J. C. Butler, K. G. Kristinsson, and B. G. Spratt. 2004. J. Infect. Dis. 190:1203-1211.
Hausdorff, W. P. 2002. Eur. J. Pediatr. 161 Suppl 2:5135-139.
World Health Organization. Pneumococcal vaccines. WHO position paper. Weekly Epidemiological Record 1999; 74: 177-184.
Whitney, C. G., M. M. Farley, J. Hadler, L. H. Harrison, N. M. Bennett, R. Lynfield, A. Reingold, P. R Cieslak, T. Pilishvili D. Jackson, R. R. Facklam, J. H. Jorgensen, A. Schuchat, and Active Bacterial Core Surveillance of the Emerging Infections Program Network. 2003. N. Engl. J. Med. 348:1737-1746.
Center, K. J. 2007. 2006. Vaccine 25:3085-3089.
Givon-Lavi, N., D. Fraser, and R. Dagan. 2003. Pediatr. Infect. Dis J. 22:524-532.
Hausdorff, W. P., D. R. Feikin, and K. P. Klugman. 2005. Lancet Infect. Dis. 5:83-93.
Fenoll, A., I. Jado, D. Vicioso, and J. Casal. 1997. J, Clin. Microbial. 35:764-766.
Mudany, M. A., K. Kikuchi, K. Totsuka, and T. Uchiyama. 2003. J. Med. Microbial. 52:975-980.
Lankinen, K. S., S. Rintamäki, R. Syrjänen, T. Kilpi, P. Ruutu, M. Leinonen. 2004. J. Microbial Methods 56:193-199.
Slotved, H. C., M. Kaltoft, I. C. Skovsted, M. B. Kerrn, and F. Espersen. 2004. J. Clin. Microbial. 42:2518-2522.
Yu, J., J. Lin, W. H. Benjamin Jr, K. B. Waites, C. H. Lee, and M. H. Nahm. 2005. J. Clin. Microbial. 43:156-162.
Brito, D. A., M. Ramirez, and H. de Lencastre. 2003. J. Clin. Microbial. 41:2378-2384.
Lawrence, E. R., D. B. Griffiths, S. A. Martin, R. C. George, and L. M. Hall. 2003. J. Clin. Microbial. 41:601-607.
Pai, R., R. E. Gertz, and B. Beall. 2006. J. Clin. Microbial. 44:124-131.
Batt, S. L., B. M. Charalambous, T. D. McHugh, S. Martin, and S. H. Gillespie. 2005. J. Clin. Microbial. 43:2656-2661.
Wang, Q., M. Wang, F. Kong, G. L. Gilbert, B. Cao, L. Wang, and L. Feng. 2007. J. Microbial. Methods 68:128-136.
Sorensen, U. B. 1993. J. Clin. Microbial. 31:2097-2100.
Lund, E. & Henrichsen, J. 1978. Laboratory diagnosis, serology and epidemiology of Streptococcus pneumoniae. In Methods in Microbiology, vol. 12, pp. 244-255. London: Academic Press.
Kauffman F, Lund E., Eddy BE, 1960, Int. Bull. Bacterial. Nomencl. Taxon. 10:31-40.
Bowen M K, Thiele L C, Stearman B D, Schaub I G, 1957, J. Lab. Clin. Med., 49(4): 641-2.
Frey T., 1995 Cytometry, 21(3): 265-274.
Brown and Robinson, 1944, The Journal of Immunology, 49: 235-250.
Anjum et al., 2006, Clinical and Vaccine Immunology, 13(5): 561-567.
Cai et al., 2005, Journal of Clinical Microbiology, 43(7): 3427-3430.
Park et al., 2000, Clinical and Diagnostic Laboratory Immunology, 7(3): 486-489.

1. A method for identifying one or more serotypes of S. pneumoniae in a sample containing, or suspected to contain, S. pneumoniae cells, comprising:
contacting an antibody array with the sample, the array comprising a set of capture antibodies immobilised on a substrate at pre-determined array positions, wherein the set of capture antibodies comprises serotype-distinguishing antibodies which differ in their binding specificity for different S. pneumoniae serotypes; and
detecting binding of S. pneumoniae cells to a subset of the set of capture antibodies, which subset corresponds to one or more particular serotypes of S. pneumoniae.

2. The method according to claim 1, wherein detecting binding of S. pneumoniae cells to a subset of the set of capture antibodies comprises determining the array position or positions at which S. pneumoniae cells are bound.

3. The method according to claim 1, wherein detecting binding comprises measurement of fluorescence or visual inspection.

4. The method according to claim 2, wherein said sample contains S. pneumoniae cells, which S. pneumoniae cells consist of substantially a single serotype and wherein the array position or positions at which the S. pneumoniae cells are bound indicate the serotype of the S. pneumoniae cells.

5. The method according to claim 2, further comprising labelling S. pneumoniae cells with at least one detectable label, wherein determining the array position or positions at which S. pneumoniae cells are bound comprises detecting the position or positions of said at least one detectable label.

6. The method according to claim 5, wherein the S. pneumoniae cells are labelled prior to contacting the array with the sample.

7. The method according to claim 5, wherein the S. pneumoniae cells are labelled at the same time as or after contacting the array with the sample.

8. The method according to claim 5, wherein said at least one detectable label comprises a label selected from the group consisting of: a fluorescent dye; a labelled antibody capable of binding an antigen present on the surface of an S. pneumoniae cell; a labelled binding agent having affinity for the surface of an S. pneumoniae cell; and a visible cell staining agent.

9. The method according to claim 8, wherein the fluorescent dye is capable of penetrating the cellular capsule of at least one serotype of S. pneumoniae.

10. The method according to claim 9, wherein the fluorescent dye is a DNA-labelling dye.

11. The method according to claim 10, wherein the fluorescent dye comprises SYTO 25.

12. The method according to claim 9, wherein said sample is subjected to a cell permeabilising treatment prior to labelling the S. pneumoniae cells with the fluorescent dye.

13. The method according to claim 12, wherein said sample contains, or is suspected to contain, serotype 3 S. pneumoniae cells.

14. The method according to claim 12, wherein said cell permeabilising treatment is selected from the group consisting of:
an alkali treatment in which the sample is exposed to pH in the range of 10-12;
an acid treatment in which the sample is exposed to pH in the range of 3-5; and
a sonication treatment in which the sample is immersed in a sonication bath for at least 30 seconds.

15. The method according to claim 8, wherein said labelled antibody is labelled with a fluorophore.

16. The method according to claim 15, wherein said fluorophore is phycoerythrin or Alexa-647.

17. The method according to claim 8, wherein said at least one detectable label comprises: said fluorescent dye and said labelled antibody.

18. The method according to claim 17, wherein said labelled antibody is capable of binding an antigen present on the surface of at least one serotype of S. pneumoniae that is impermeable to said fluorescent dye.

19. The method according to claim 17, wherein said labelled antibody is capable of binding an antigen present on the surface of S. pneumoniae serotype 3.

20. The method according to claim 1, further comprising a step of incubating said sample under bacterial growth conditions prior to contacting the array with said sample.

21. A method for identifying one or more serotypes of S. pneumoniae in a sample containing, or suspected to contain, S. pneumoniae cells, comprising the following steps:
(i) optionally, incubating a sample containing, or suspected to contain, S. pneumoniae cells under cell growth conditions;
(ii) optionally, determining the concentration of bacterial cells in the sample;
(iii) optionally, adjusting the concentration of bacterial cells in the sample;
(iv) optionally, subjecting the sample to one or more cell permeabilising treatment steps selected from the group consisting of: an alkali treatment in which the sample is exposed to pH in the range of 10-12, an acid treatment in which the sample is exposed to pH in the range of 3-5, and a sonication treatment in which the sample is immersed in a sonication bath for around 1 minute;
(v) contacting an antibody array with the sample, the array comprising a set of capture antibodies immobilised on a substrate at pre-determined array positions, wherein the set of capture antibodies comprises serotype-distinguishing antibodies which differ in their binding specificity for different S. pneumoniae serotypes;
(vi) optionally, subjecting the array substrate to one or more wash steps to remove unbound cells;
(vii) contacting a plurality of S. pneumoniae cells bound to one or more of the capture antibodies with at least one detectable label;
(viii) optionally, subjecting the array substrate to one or more wash steps to remove excess detectable label; and
(ix) determining the array position or positions of said at least one detectable label, whereby said array position or positions correlate to a subset of the set of capture antibodies to which subset the labelled S. pneumoniae cells are bound, which subset corresponds to one or more particular serotypes of S. pneumoniae.

22. The method according to claim 21, wherein determining the array position comprises measurement of fluorescence or visual inspection.

23. The method according to claim 1, wherein said sample is a sample that tests positive in an optoquin sensitivity test.

24. The method according to claim 1, wherein said sample is a clinical sample obtained from a mammalian subject, a laboratory sample or an environmental sample.

25. The method according to claim 24, wherein the sample is a clinical sample obtained from a mammalian subject having or suspected to have a pneumococcal infection, and wherein one or more serotypes of S. pneumoniae are identified in said sample thereby indicating the serotype or serotypes of S. pneumoniae associated with the pneumococcal infection.

26. An antibody array for serotyping S. pneumoniae cells, comprising a set of capture antibodies immobilised on a substrate at pre-determined array positions, wherein the set of capture antibodies comprises serotype-distinguishing antibodies which differ in their binding specificity for different S. pneumoniae serotypes.

27. The antibody array according to claim 26, wherein the set of capture antibodies comprises a plurality of type-specific antibodies, each type-specific antibody being selective for a single serotype of S. pneumoniae.

28. The antibody array according to claim 26, wherein the set of capture antibodies comprises a plurality of factor-specific antibodies, each factor-specific antibody being selective for one or more serotypes of S. pneumoniae of a single S. pneumoniae serotype group.

29. The antibody array according to claim 26, wherein the set of capture antibodies comprises a plurality of group-specific antibodies, each group-specific antibody being selective for a single S. pneumoniae serotype group.

30. The antibody array according to claim 26, wherein the set of capture antibodies comprises a plurality of pooled antibodies.

31. The antibody array according to claim 26, wherein the set of capture antibodies comprises polyclonal antisera raised against S. pneumoniae capsule antigens.

32. The antibody array according to claim 26, wherein the set of capture antibodies further comprises omniserum that reacts with serotypes 1, 2, 3, 4, 5, 6A, 6B, 7F, 7A, 7B, 7C, 8, 9A, 9L, 9N, 9V, 10F, 10A, 10B, 10C, 11F, 11A, 11B, 11C, 11D, 12F, 12A, 12B, 13, 14, 15F, 15A, 15B, 15C, 16F, 16A, 17F, 17A, 18F, 18A, 18B, 18C, 19F, 19A, 19B, 19C, 20, 21, 22F, 22A, 23F, 23A, 23B, 24F, 24A, 24B, 25F, 25A, 27, 28F, 28A, 29, 31, 32F, 32A, 33F, 33A, 33B, 33C, 33D, 34, 35F, 35A, 35B, 35C, 36, 37, 38, 39, 40, 41F, 41A, 42, 43, 44, 45, 46, 47F, 47A and 48, and optionally serotype 6C, of S. pneumoniae.

33. The antibody array according to claim 26, wherein the set of capture antibodies further comprises anti C-polysaccharide antibodies that bind cell wall polysaccharide common to all pneumococci.

34. The antibody array according to claim 26, wherein the serotype-distinguishing antibodies are capable of distinguishing the following S. pneumoniae serotypes: 1, 2, 4, 5, 6A, 6B, 7F, 8, 9N, 9V, 10A, 11A, 12F, 14, 15B, 17F, 18C, 19A, 19F, 20, 22F, 23F and 33F, and optionally S. pneumoniae serotype 3.

35. The antibody array according to claim 34, wherein the set of capture antibodies comprises the polyclonal antisera set out in Table 4, optionally without type-specific antibody 3.

36. The antibody array according to claim 26, wherein the serotype-distinguishing antibodies are capable of distinguishing the following S. pneumoniae serotypes: 1, 2, 3, 4, 5, 6A, 6B, 7F, 7A, 7B, 7C, 8, 9A, 9L, 9N, 9V, 10F, 10A, 10B, 10C, 11F, 11A, 11B, 11C, 11D, 12F, 12A, 12B, 13, 14, 15F, 15A, 15B, 15C, 16F, 16A, 17F, 17A, 18F, 18A, 18B, 18C, 19F, 19A, 19B, 19C, 20, 21, 22F, 22A, 23F, 23A, 23B, 24F, 24A, 24B, 25F, 25A, 27, 28F, 28A, 29, 31, 32F, 32A, 33F, 33A, 33B, 33C, 33D, 34, 35F, 35A, 35B, 35C, 36, 37, 38, 39, 40, 41F, 41A, 42, 43, 44, 45, 46, 47F, 47A and 48, and optionally serotype 6C.

37. The antibody array according to claim 26, wherein the set of capture antibodies comprises:
factor-specific antibodies selective for serotype antigenic forms 6b, 6c, 7b, 7c, 9e, 9g, 10b, 10d, 11b, 11c, 11f, 12b, 12e, 15b, 15c, 15h, 16b, 17b, 18c, 18f, 19b, 19c, 7h, 22b, 23b, 23c, 33b and 20b;
type-specific antibodies selective for serotypes 1, 2, 3, 4, 5, 8, 13, 14, 20, 21, 27, 29, 31, 34, 36, 37, 38 and 39; and
group-specific antibodies selective for serogroups: 6, 7, 9, 10, 11, 12, 15, 16, 17, 18, 19, 20, 22, 23, 24, 25, 28, 32, 33, 35, 41 and 47.

38. The antibody array according to claim 26, wherein the antibody array is an antibody microarray.

39. The method according to claim 1, wherein said antibody array comprises a set of capture antibodies immobilised on a substrate at pre-determined array positions, wherein the set of capture antibodies comprises serotype-distinguishing antibodies which differ in their binding specificity for different S. pneumoniae serotypes.

40. A kit for serotyping S. pneumoniae comprising an antibody array as defined in claim 26 and one or more reagents, controls and/or standards, and optionally comprising computer readable media having stored thereon a computer program capable of analysing an array read-out, thereby facilitating serotyping of a sample.

41. A method of complementary labelling of S. pneumoniae cells, comprising contacting a sample that contains, or is suspected to contain, S. pneumoniae cells with a first detectable label that is capable of labelling at least a subset of S. pneumoniae serotypes and wherein said sample is further contacted with a second detectable label that is capable of labelling at least one S. pneumoniae serotype that is not labelled or is only poorly labelled by said first detectable label.

42. The method according to claim 41, wherein said first detectable label comprises a fluorescent dye and said second detectable label comprises a labelled antibody that is capable of binding an antigen present on the surface of at least one serotype of S. pneumoniae that is impermeable to said fluorescent dye.
